(19) United States
(12) Patent Application Publication
(10) Pub. No.: US 2014/0372971 A1
(43) Pub. Date: Dec. 18, 2014

(54) PORTABLE BUSINESS LOGIC

(71) Applicant: Microsoft Corporation, Redmond, WA (US)

(72) Inventors: Anusha Shankar, Woodinville, WA (US); Bharath Swaminathan, Renton, WA (US); Suprita Pagad, Bellevue, WA (US)

(21) Appl. No.: 13/918,988

(22) Filed: Jun. 16, 2013

(51) Int. Cl. G06F 9/44

(52) U.S. Cl. CPC G06F 8/34
USPC 717/106

(57) ABSTRACT

Records in a computer system have associated logic rules. The logic rules can be created and modified using natural language expressions. The created or modified logic is converted to a form that can be run on a plurality of different clients, each using a different language.

### BACKGROUND

Computer systems are currently in wide use. Many such systems include forms that have associated logic applied to them.

For instance, some computer systems include business systems, such as enterprise resource planning (ERP) systems, customer relations management (CRM) systems, line-of-business (LOB) systems, etc. These types of computer systems can be quite large. For instance, some such systems can include thousands of different forms that represent different items of the business system. Such items can include entities, which are data records that represent an underlying item. For instance, a customer entity is a business record that describes and represents a customer. A vendor entity includes information that describes and represents a vendor. Product entities describe and represent products, inventory entities describe certain aspects of inventory, opportunity entities describe and represent business opportunities, quote entities describe and represent quotes that are made to customers, etc.

Each of these entities can have an associate form. In addition, the forms can be related to various business activities. For instance, an order form can represent an underlying order entity that describes an order.

Each of these different types of forms may have associated business logic rules applied to them. By way of example, the business logic rules may indicate what fields are to show on a given form, under certain criteria. Also, the business logic rules may implement certain validations or they may implement a wide variety of other business logic.

Business systems are also often run in multiple contexts. For instance, a business system may be accessed by, and available to, an end user who is accessing the system using a web browser, a personal information manager, or another type of application that allows the user to view the forms. In addition, the business system may be accessed by a user through a user device that has a mobile companion application. As another example, the business system may be accessible to software developers who develop, customize, or otherwise modify or administer the system.

These different clients (web clients, mobile clients and server clients) often operate using dramatically different code language. By way of example, the web clients and mobile clients may operate using JAVA script, while the server client operates using C#. These are examples only, and a wide variety of different types of code languages can be used by clients as well. Where the clients operate using different code languages, the corresponding business logic is separately coded in all of those different languages.

The discussion above is merely provided for general background information and is not intended to be used as an aid in determining the scope of the claimed subject matter.

### SUMMARY

Records in a computer system have associated logic rules. The logic rules can be created and modified using natural language expressions. The created or modified logic is converted to a form that can be run on a plurality of different clients, each using a different language.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system architecture.

FIG. 2 is a flow diagram showing one embodiment of the operation of the architecture shown in FIG. 1 in creating new business logic applied to a form.

FIGS. 2A-2R are illustrative user interface displays.

FIG. 3 is a flow diagram illustrating one embodiment of the operation of the business system architecture shown in FIG. 1 in allowing a user to modify existing business logic.

FIGS. 3A-3F are illustrative user interface displays.

FIG. 4 is one embodiment of the architecture shown in FIG. 1 deployed in various other architectures.

FIGS. 5-10 show various embodiments of mobile devices.

FIG. 11 is a block diagram of one illustrative computing environment.

### DETAILED DESCRIPTION

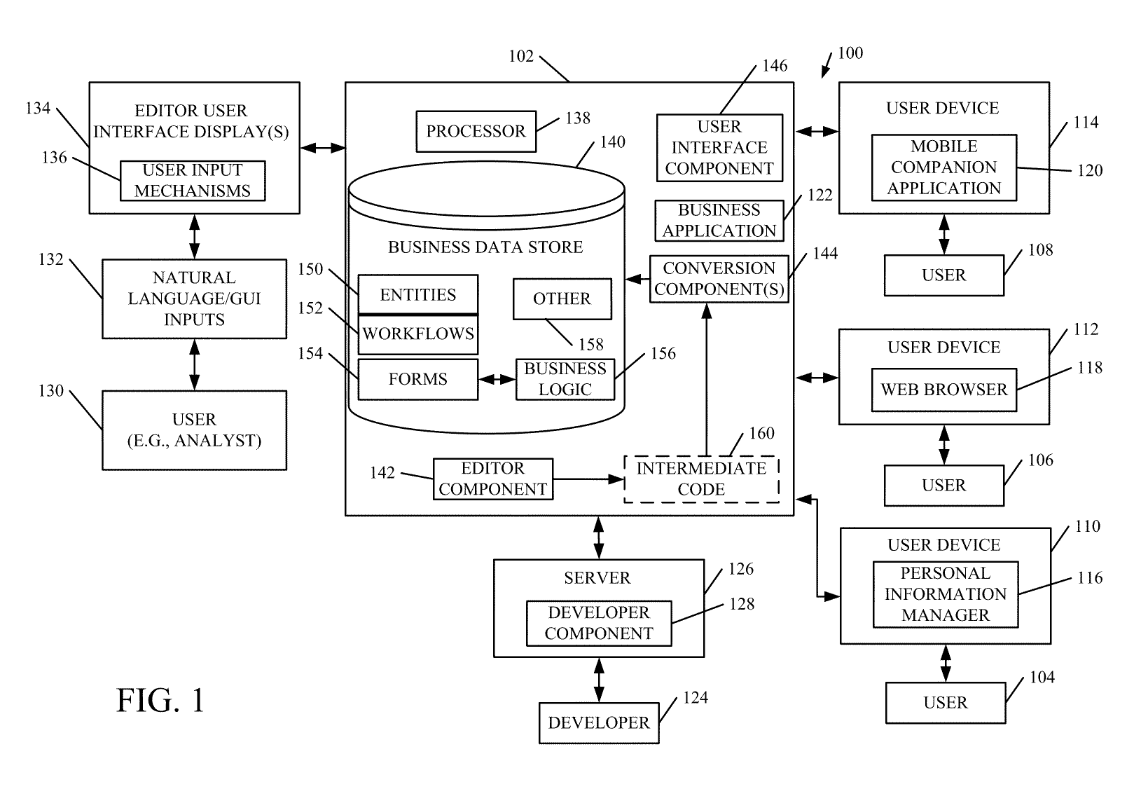

FIG. 1 is a block diagram of one illustrative embodiment of a business system architecture 100. Architecture 100 includes business system 102 that is accessible by a plurality of users 104, 106 and 108 through corresponding user devices 110, 112 and 114, respectively, in order to conduct business operations. It can be seen that users 104, 106 and 108 access business system 100 using different mechanisms. User 104, for instance, uses a personal information manager on device 114. User 106 uses a web browser 116 and user 108 uses a mobile companion application 120. Mobile companion application 120 is illustratively a companion to a business application 122 that is implemented by business system 102.

FIG. 1 also shows that business system 102 is illustratively accessible by a developer 124, through a server (or server environment) 126 which includes a developer component 128. Developer 124 uses developer component 128 to interact with business system 102.

FIG. 1 also shows that business system 102 is illustratively accessible by another user 130 that may be, for instance, an analyst or another user that need not necessarily know how to program (e.g., user 130 need not be a developer 124) but illustratively has business knowledge and knows how to set up business logic and other items in business system 102. User 130 does this by providing inputs to system 102. In one embodiment, they are natural language inputs or inputs through graphical user interface (GUI) input mechanisms 132 through editor user interface displays 134 and specifically through user input mechanisms 136 on those displays.

FIG. 1 also shows that business system 102 illustratively includes processor 138, business data store 140, editor component 142, one or more conversion components 144, and user interface component 146. User interface component 146 illustratively generates user interface displays that can be displayed to the various users and developers in architecture 100. They can be generated by other components or by interface components in the other devices as well. The user interface displays illustratively include user input mechanisms that the various users and developers can interact with in order to manipulate and control business system 102.

The user input mechanisms can include a wide variety of different types of user input mechanisms, such as buttons, icons, drop down menus, check boxes, text boxes, tiles, links, etc. In addition, the user input mechanisms can be actuated by the users in a variety of different ways. For instance, they can be actuated using a point and click device (such as a mouse, track ball, etc.). In addition, if the business system 102 (or the device used by any given user) includes speech recognition components, then the user input mechanisms can be actuated using speech commands. Further, where the user interface displays are displayed on a touch sensitive screen, then the user input mechanisms can be actuated using touch gestures (such as with the user's finger, stylus, etc.).

Business application 122 illustratively performs business operations in order to conduct the business of the various users and developers shown in FIG. 1. Business application 122 can illustratively operate on business data in business data store 140. The business data illustratively includes entities 150, work flows 152, forms 154 (with corresponding business logic 156) and other elements of data (such as other business records, etc.) as indicated by block 158.

FIG. 1 shows that business data store 140 is a single data store and it is local to business system 102. However, it could be multiple different data stores, and all of them could be local to business system 102, all of them could be remote from business system 102, or some could be local while others are remote.

Processor 138 is illustratively a computer processor with associated memory and timing circuitry (not separately shown). It is illustratively a functional part of business system 102 and is activated by, and facilitates the functionality of, other components, applications, or other items in business system 102. It will also be noted, in some embodiments, user devices 110, 112, and 114, and server 126, will also illustratively include processors as well, although they are not shown for the sake of simplicity.

Before describing the operation of architecture 100 in more detail, a brief overview will first be provided. Editor component 142 illustratively uses user interface component 146 to generate user interface displays 134 for use by user 130. In one embodiment, the user interface displays 134 include user input mechanisms 136 that allow user 130 to provide natural language inputs or GUI inputs 132 in order to create new business logic 156, associated with the forms 154 (or entities or work flows or other business records) used by business system 102. Editor component 142 also illustratively generates user interface displays that allow user 130 to edit existing business logic 156.

Once the business logic is either generated or edited, editor component 142 illustratively automatically generates intermediate code 160 that is then automatically converted by conversion component(s) 144 into code that can be used by the various mechanisms in user devices 110, 112, and 114, as well as in server environment 126. By automatically, it is meant that it is done substantially without any other user involvement or action. For instance, in one embodiment, conversion components 134 include a component to convert intermediate code 160 into code that is understandable by mobile companion application 120. In another embodiment, a conversion component 144 converts intermediate code 160 into code that is understandable by web browser 116, while in other embodiments, conversion component 144 converts intermediate code 160 into code that is understandable by personal information manager 114, and/or developer component 128. Also, in one embodiment, the conversion components 144 can operate directly on the user inputs provided by user 130 to generate the code for the various clients and no intermediate code is generated.

In current systems, the business logic often has to be separately coded by two or more separate individuals. The code has to be generated to implement the functionality of the business logic in the various contexts defined by the various users. For instance, in embodiments shown in FIG. 1, the business logic (once it was provided by user 130 through editor component 132) would need to be coded by a separate person into the code understandable by mobile companion application 120. It has also separately coded into a different language that was understandable by web browser 116, and into yet another language that was understandable by personal information manager 114, and into even another language that was understandable by developer component 128. This type of repeated human coding of the same functionality into all of these multiple different contexts (or different languages) was time-consuming, cumbersome, and often error-prone.

In contrast, editor component 142 illustratively converts the inputs provided by user 130 into intermediate code 160 which is understandable by conversion components 144 and easily convertible into the language needed for the different contexts in which the business system 102 is deployed. This is done automatically. By way of one example, editor component 142 can generate intermediate code 160 as XML or a variant thereof. A given conversion component 144 can be included in business system 102 for each context in which the business system 102 is deployed. Therefore, there can be a conversion component 144 to convert the XML (or the intermediate code 160) into code understandable by mobile companion application 120. There can also be another conversion component 144 to convert intermediate code 160 into code understandable by web browser 116. There can be yet another conversion component 144 that converts the intermediate code 160 into code that is understandable by personal information manager 114, and yet another conversion component 144 that converts intermediate code 160 into code that is understandable by developer component 128.

Once these conversions have been made, they are stored in business data store 140 and associated with the forms, work flows, or entities (or other business records) to which they belong. They are accessible by the various users, through the various user devices and server environments, so that all of the people accessing business system 102 can illustratively run the new or modified business logic, without that new or modified business logic needing to be re-coded, by hand, into a language suited to each different context. Instead, it is initially coded in a format that can be easily converted into something understandable by all the various contexts. Thus, user 130 can simply can be a business analyst that only understands how to configure business logic within business system 102, using natural language inputs and graphical user interface inputs and need not necessarily be someone who is adept at coding in various languages.

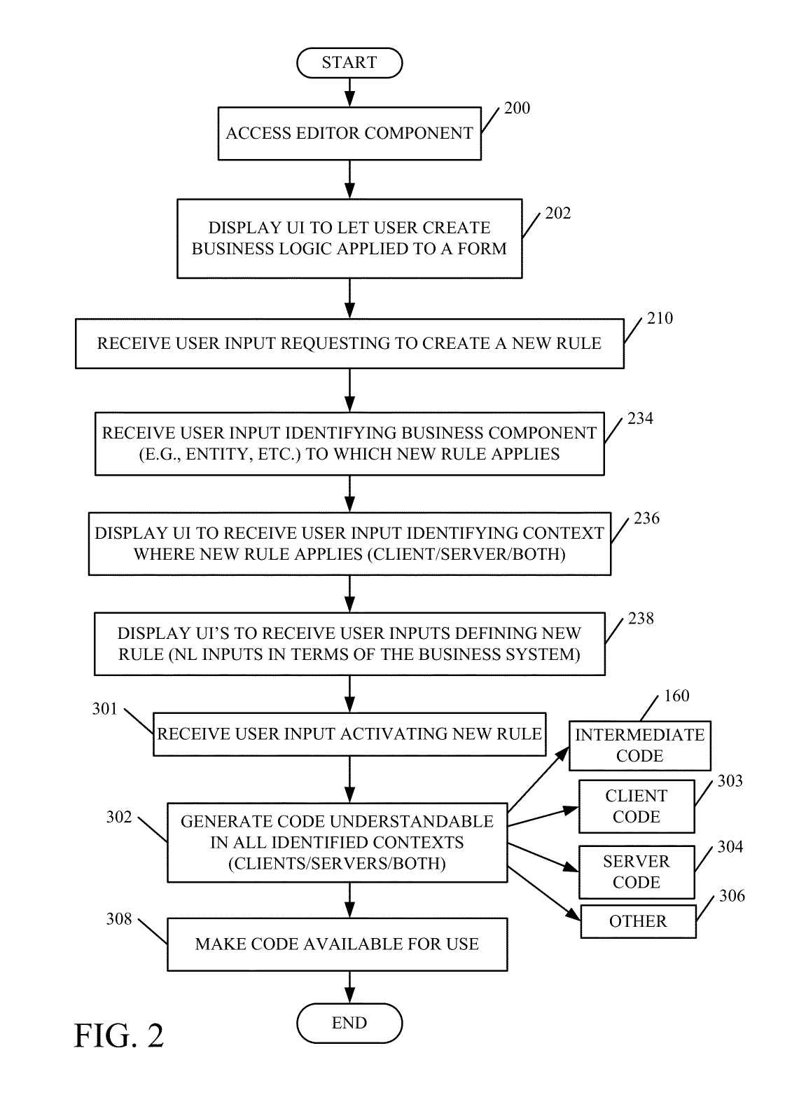

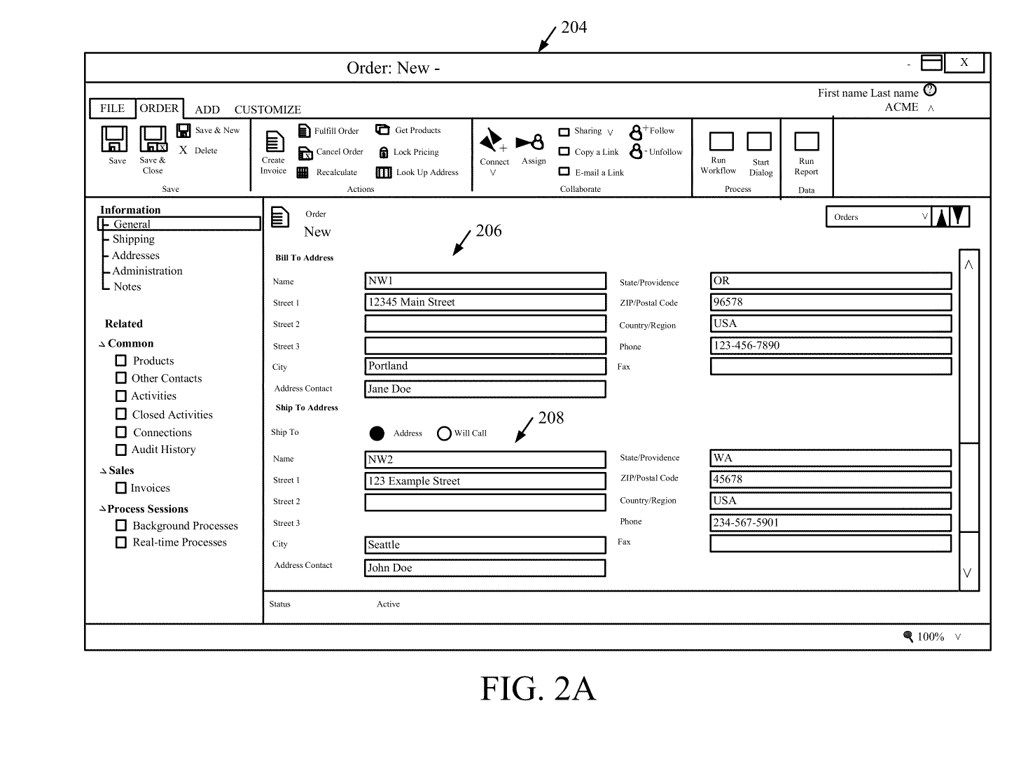

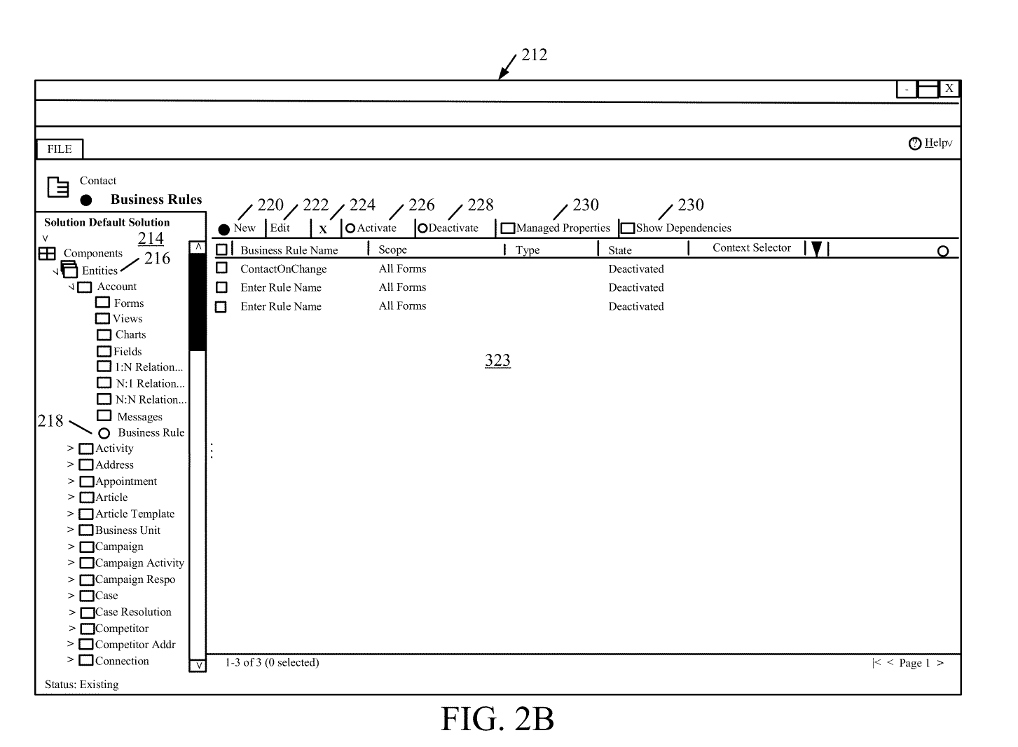

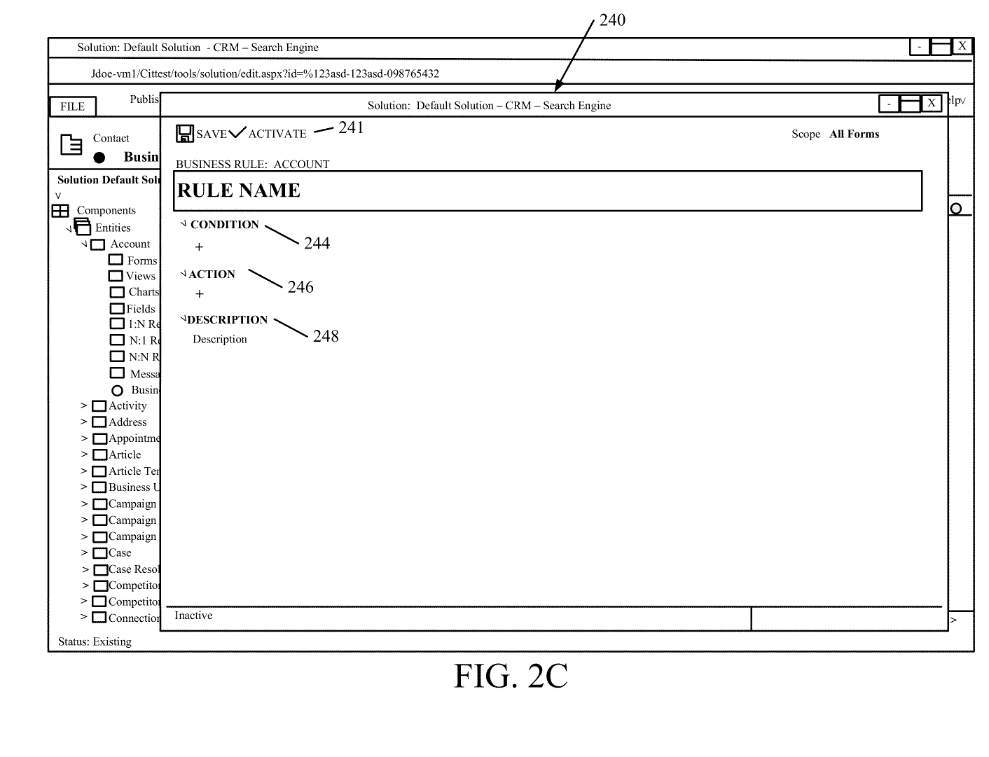

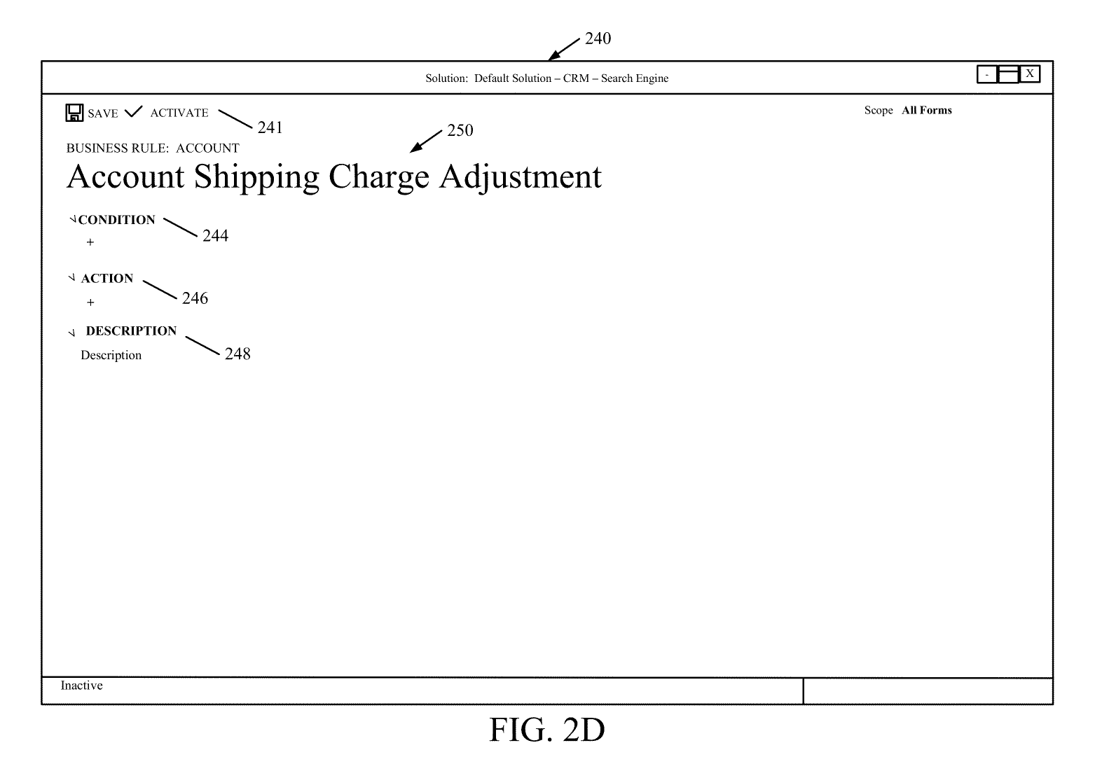

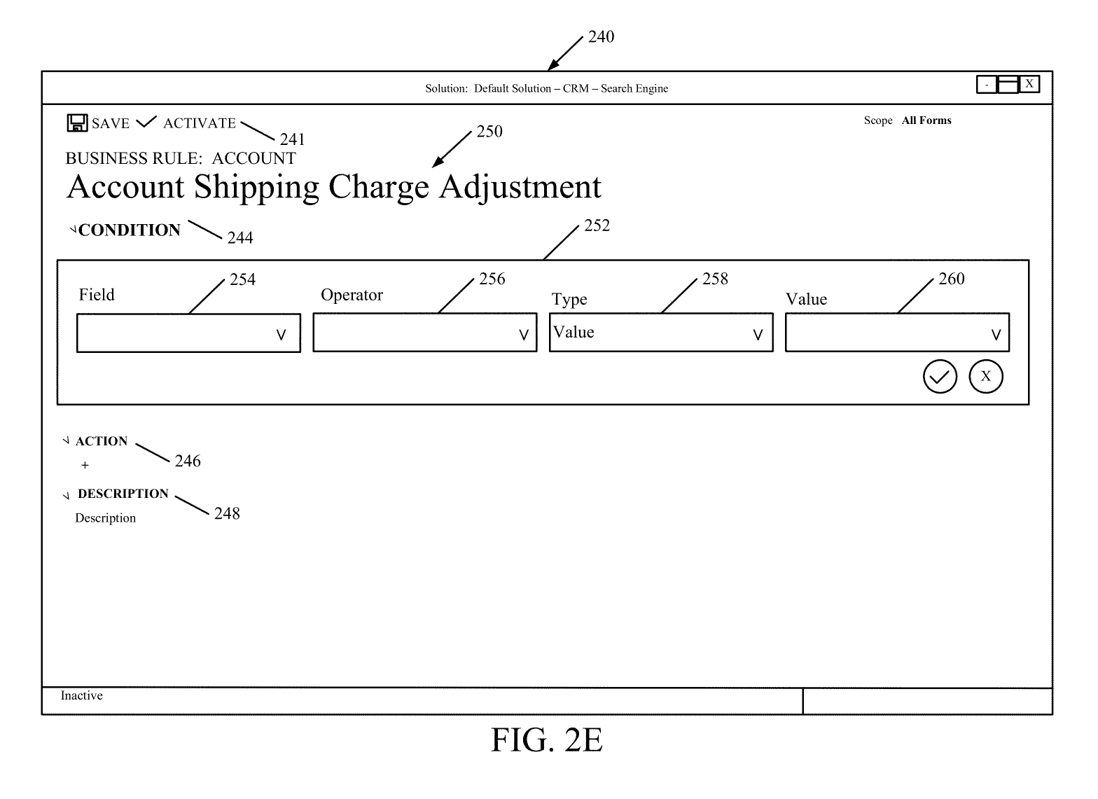

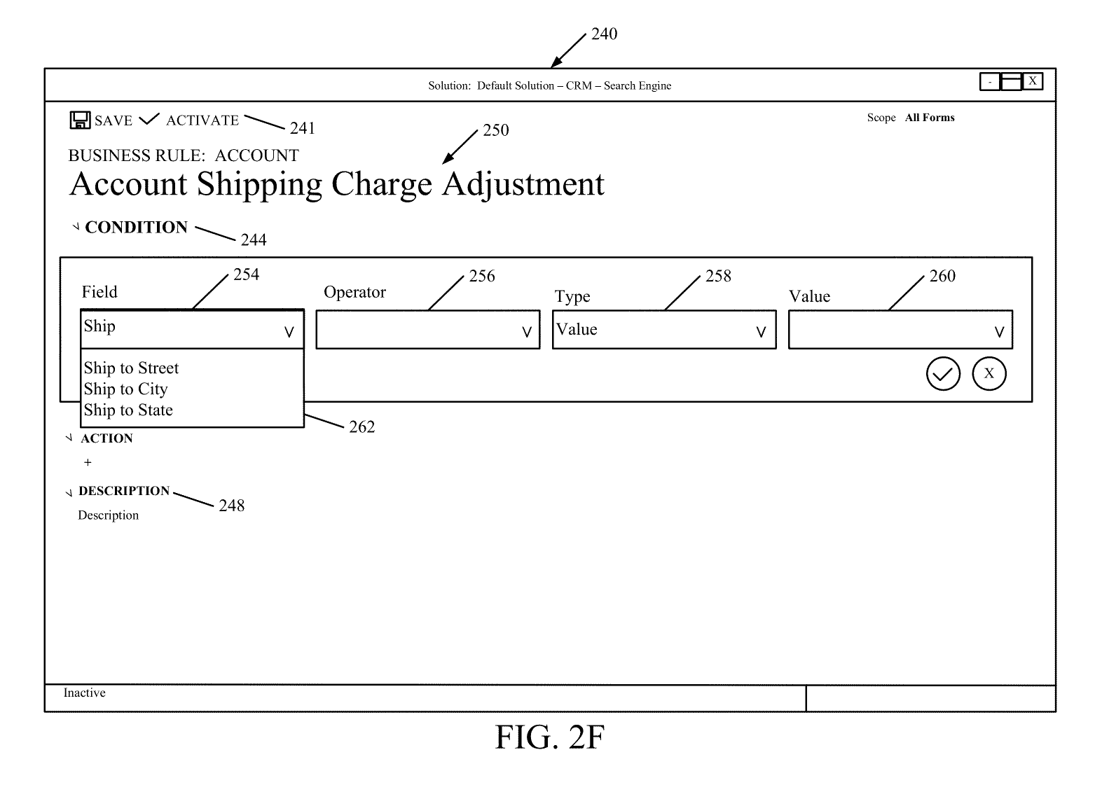

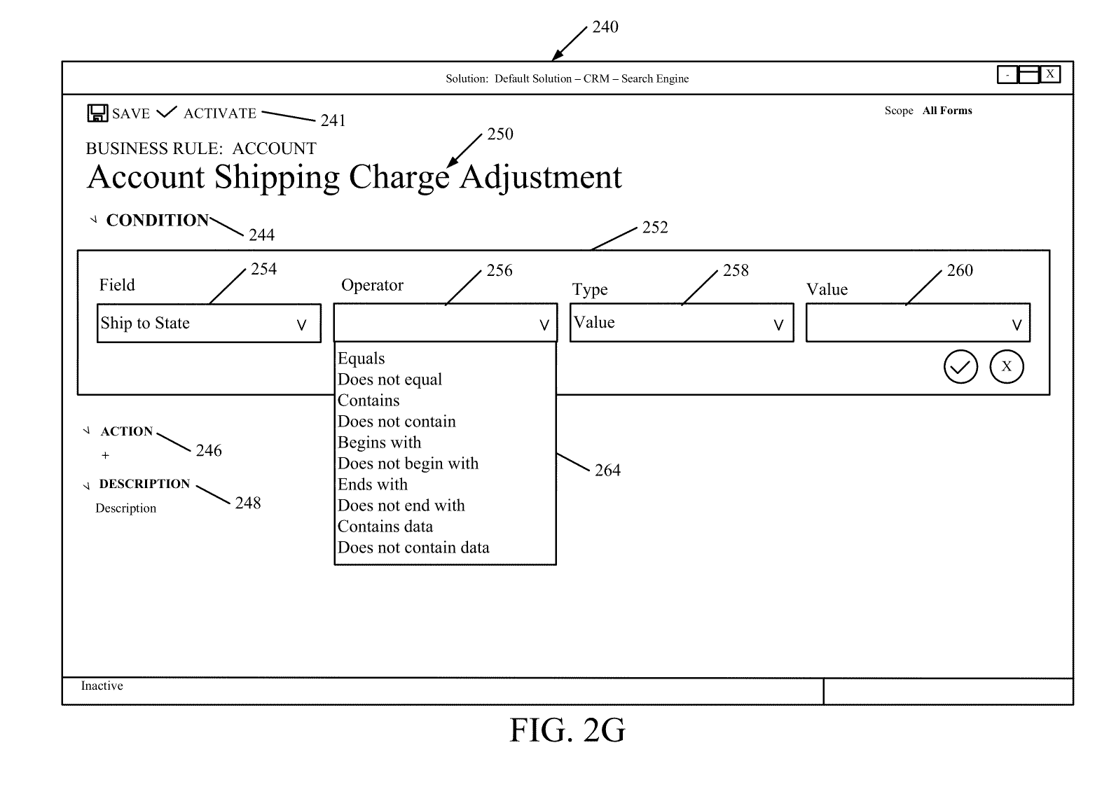

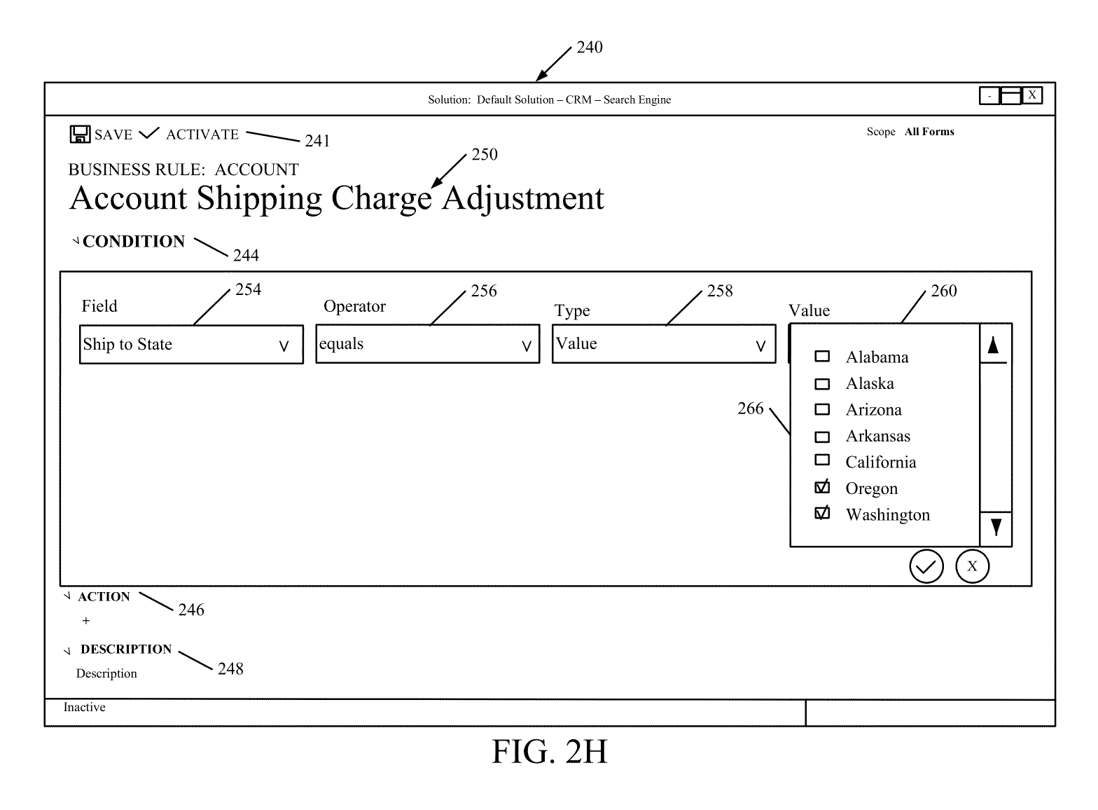

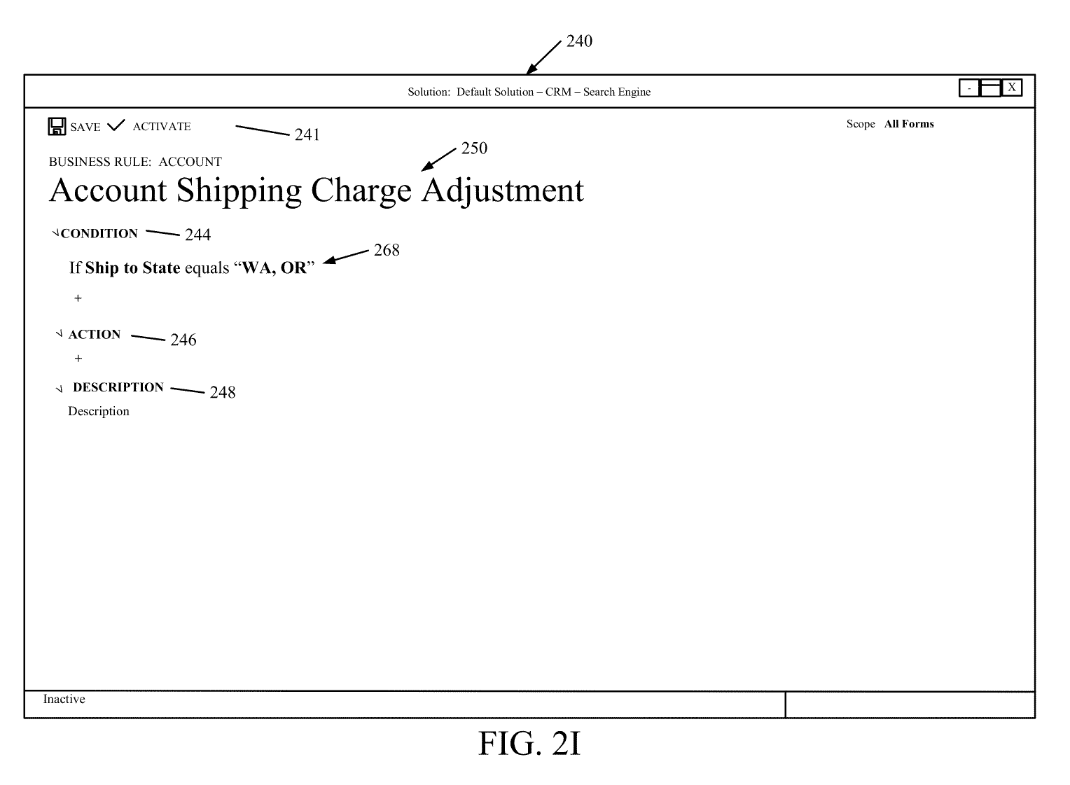

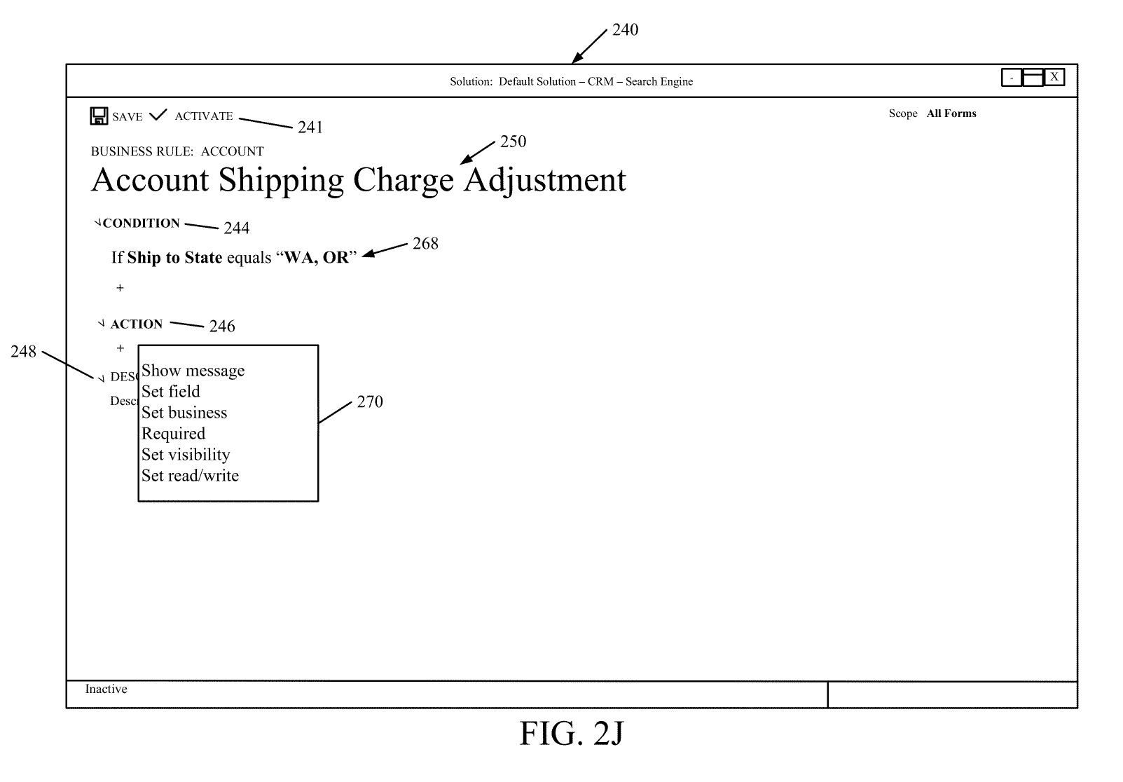

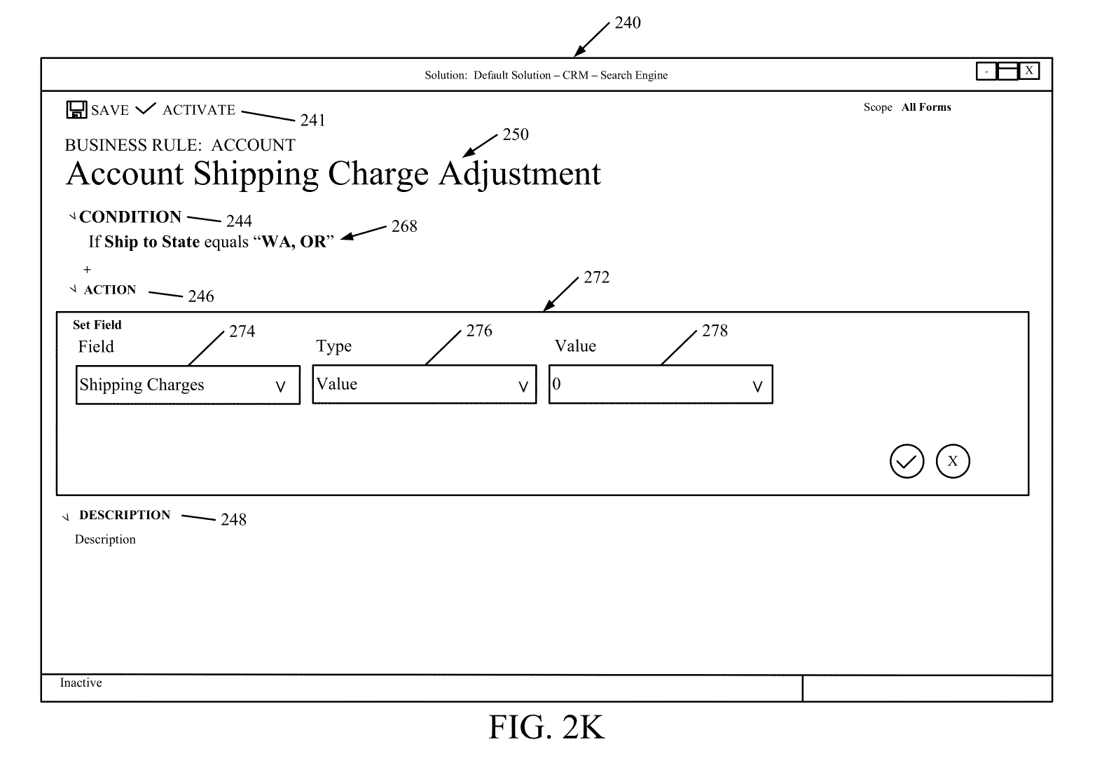

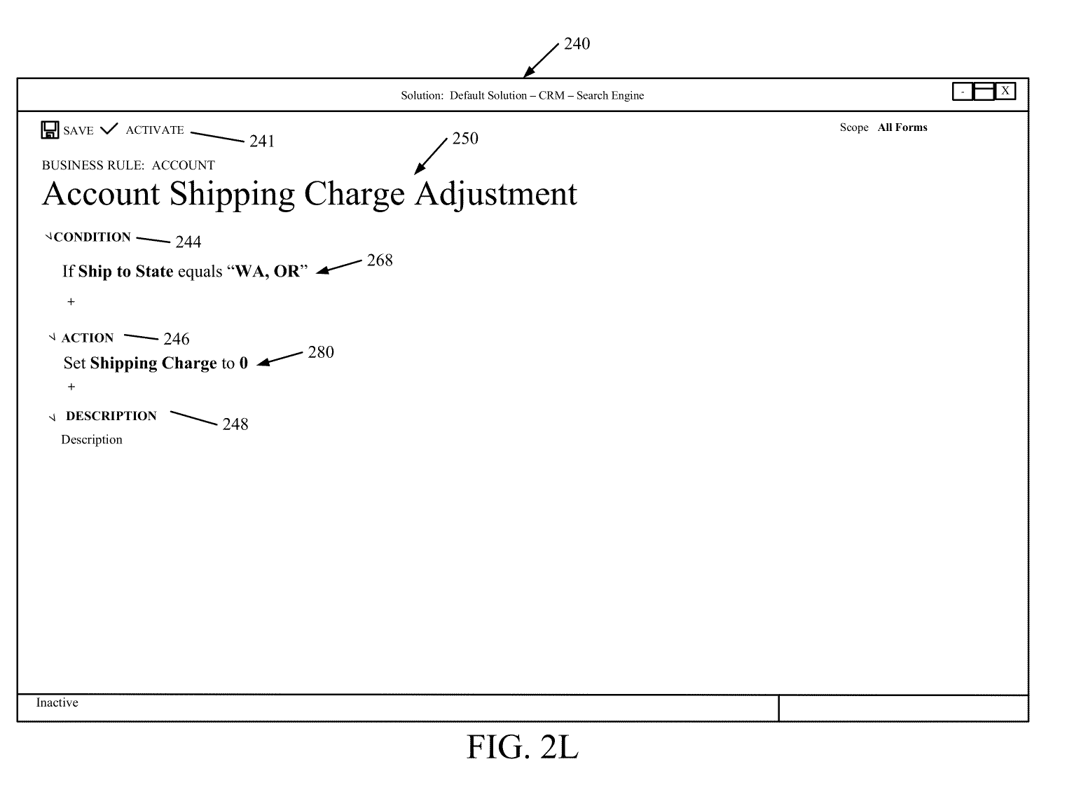

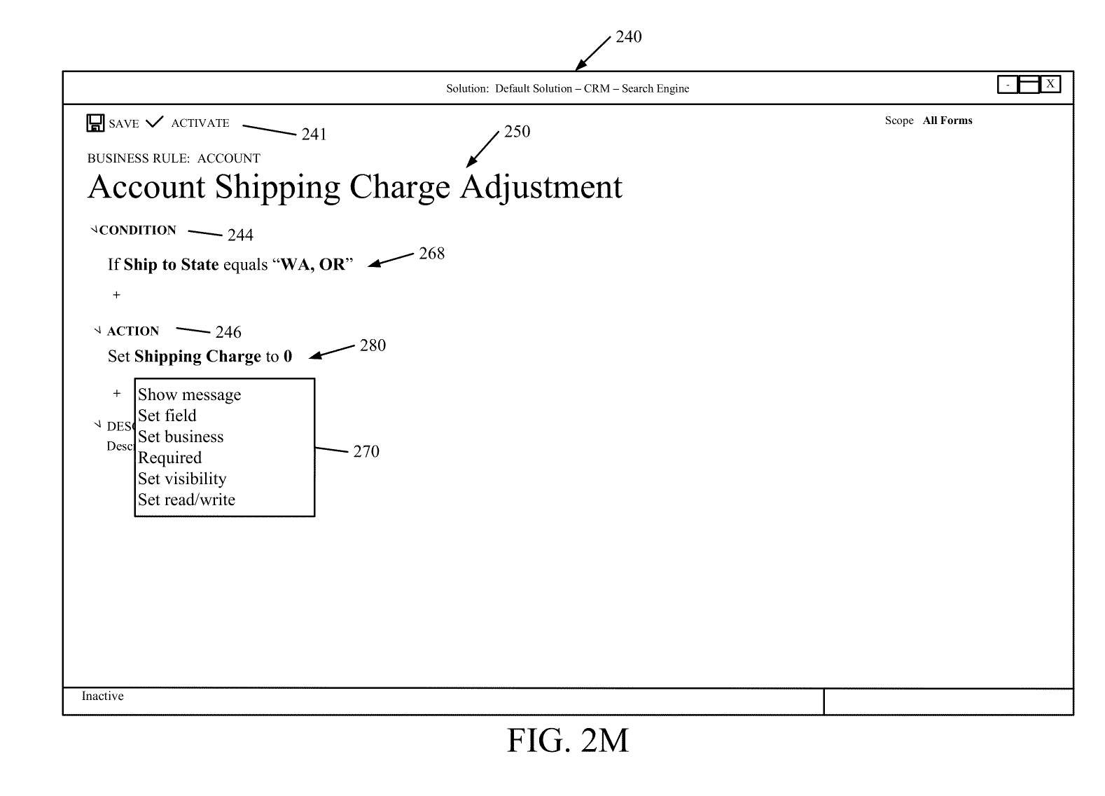

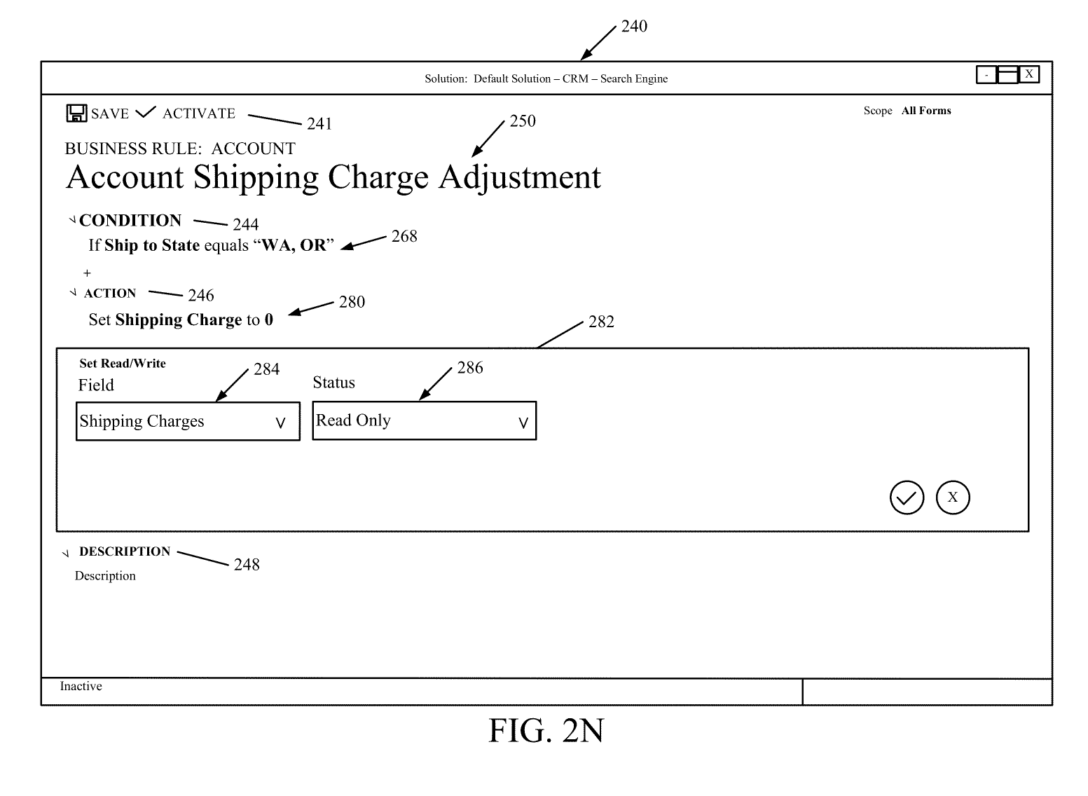

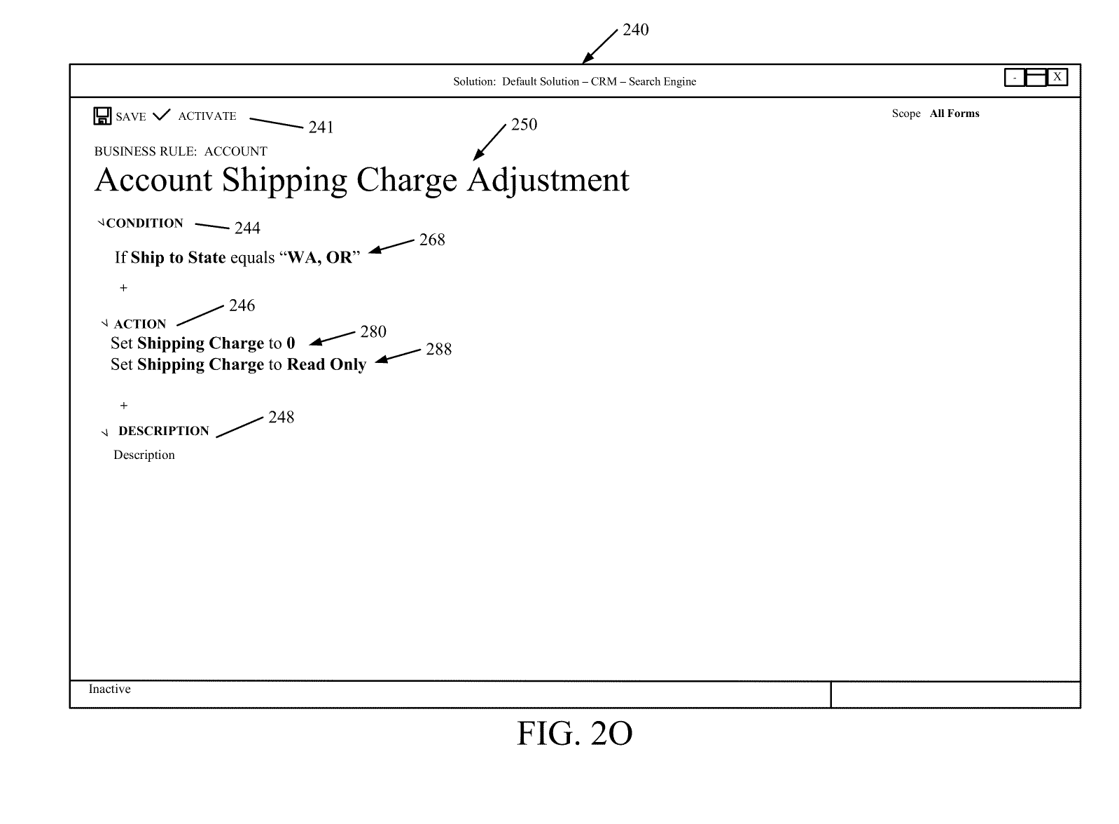

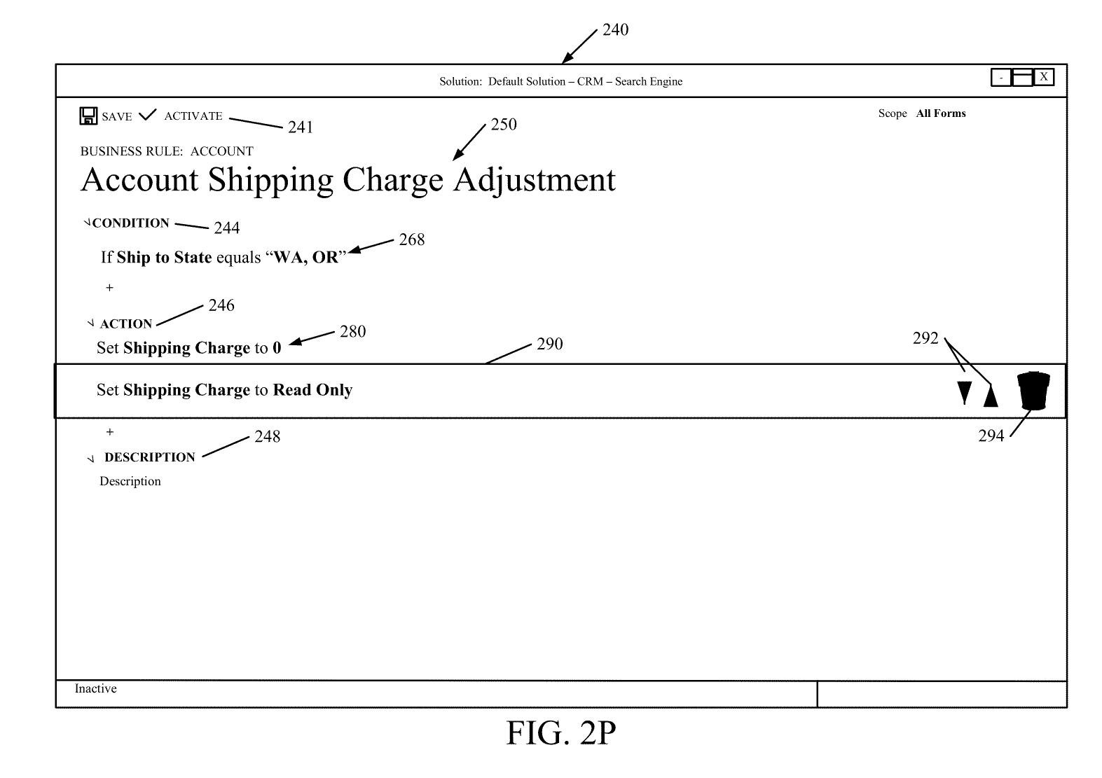

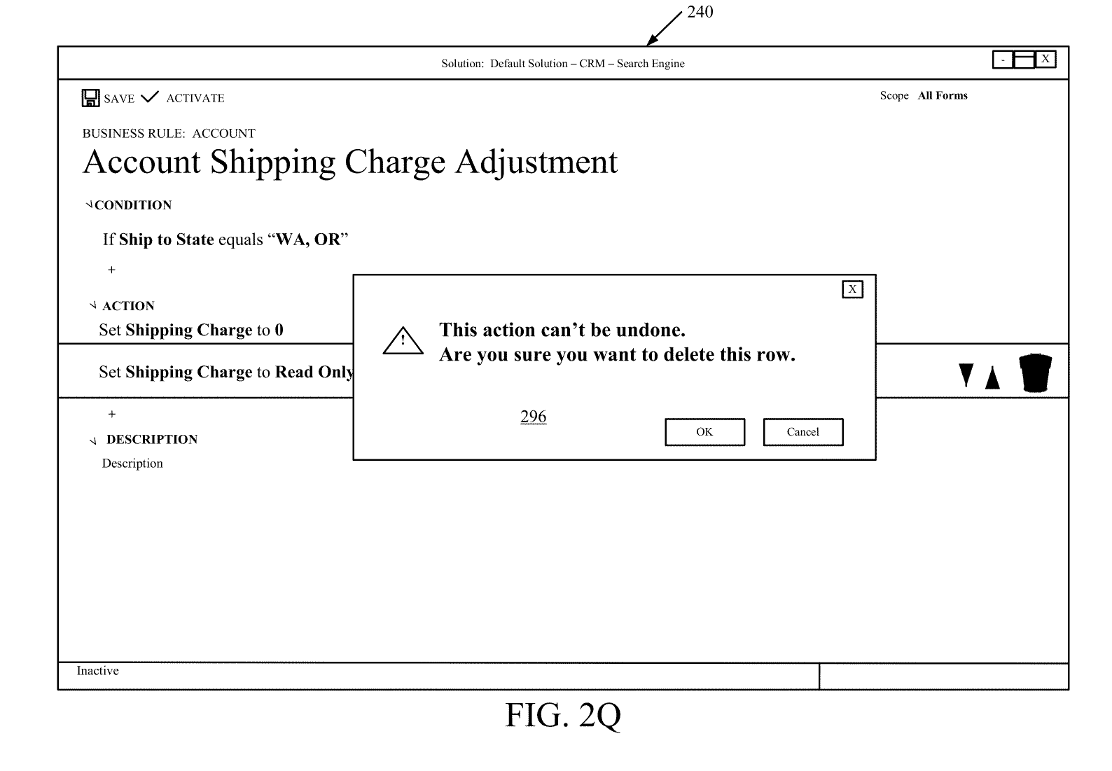

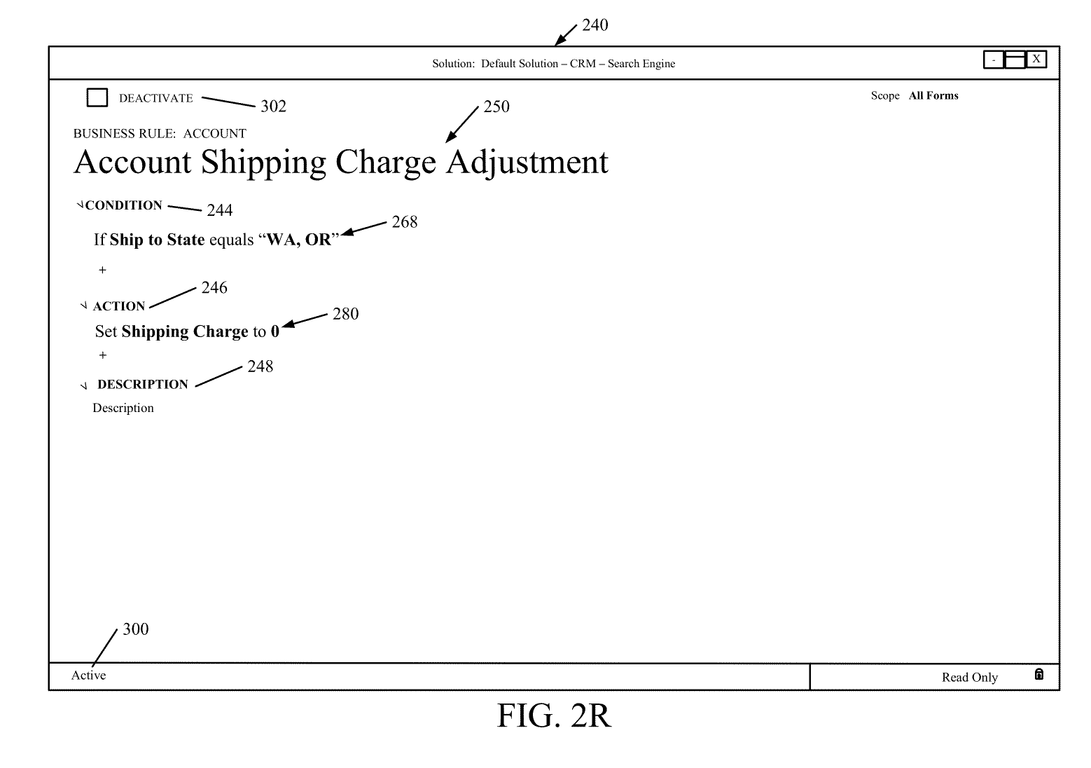

FIG. 2 is a flow diagram illustrating one embodiment of the overall operation of the system shown in FIG. 1 in allowing user 130 to generate new business logic applied to a given form. User 130 first accesses editor component 142. This can be done in a variety of different ways. For instance, user 130 can log into or otherwise access business system 102 by providing suitable authentication inputs. In response, business system 102 can illustratively provide a user interface display that allows user 130 to access editor component 142 in order to create new business logic. Accessing editor component 142 is indicated by block 200 in FIG. 2.

Editor component 142 then generates editor user interface displays 134 with user input mechanisms 136 that allow user 130 to indicate that he or she wishes to create a new item of business logic. This is indicated by block 202 in FIG. 2.

By way of example, assume that user 130 wishes to create one or more new business logic rules for orders that are placed within business system 102 by purchasers. FIG. 2A shows one exemplary user interface display 204 that corresponds to a new order entity. It can be seen that user interface display 204 includes a “bill to address” portion 206 that allows the user to input the address to which the bills are to be sent. In addition, user interface display 204 includes a “ship to address” portion 208 that allows a user to identify the address where goods are to be shipped. For purposes of the present example, assume that user 130 wishes to create a new business logic rule corresponding to orders that indicates that if the state of Washington or the state of Oregon is the state in the “ship to address” portion 208, then the shipping charge is waived (or set to zero). Assume also that user 130 wishes to set the shipping charge input field to read only, so that a shipping charge does not inadvertently get placed in that field during the order process.

In this scenario, once user 130 accesses editor component 142, editor component 142 uses user interface component 146 to generate a user interface display with user input mechanisms that allow user 130 to indicate that he or she wishes to create a new business logic rule. This is indicated by block 210 in FIG. 2. FIG. 2B shows one illustrative user interface display 212 that indicates this. It can be seen that user interface display 212 includes a hierarchical structure shown in pane 214 that allows the user to choose an item in business system 102 that the user wishes to edit. It can be seen that the user has chosen an entity item 216 and has actuated the business rules node 218 in the hierarchical tree structure.

User interface display 212 also illustratively includes a context selector control 231. Context selector control 231 allows the user 130 to select the contexts to which the business logic rule will apply. In the embodiment shown in FIG. 2B, context selector 231 is shown as a drop down menu. Thus, in the embodiment discussed above with respect to FIG. 1, when the user actuates the drop down menu 231, the user is able to select the server context, the personal information manager context, the web browser context, and/or the mobile companion application context so that the newly created business logic rule is applied to all selected contexts.

User interface display 212 also includes a new button 220, an edit button 222, a delete button 224, activate and deactivate buttons 226 and 228, respectively, and additional buttons 230 for providing additional functions. When the user actuates the business rules node 218 in the hierarchical structure, the editor component 142 displays all of the business rules in business rule pane 232. Thus, the user can select one of the already-existing business rules and edit it by actuating the edit button 222, or the user can actuate the new button 220 to create a new business logic rule.

Receiving the user input actuating new button 220 to create a new business logic rule is indicated by block 210 in FIG. 2. Receiving the user input identifying the item in the hierarchical structure in pane 214 is indicated by block 234 in FIG. 2, and displaying the user interface to receive the user input to select the context for application of the new business logic rule is indicated by block 236 in FIG. 2.

Once the user has provided these inputs, editor component 142 uses user interface component 146 to generate user interface displays that allow user 130 to provide user inputs defining the new rule. In one embodiment, these inputs can be provided in natural language form, or through graphical user interface input mechanisms 136. Displaying these user interface displays and receiving the user inputs is indicated by block 238 in the flow diagram of FIG. 2. FIGS. 2C-2Q are illustrative user interface displays that show an example of this.

FIG. 2C shows user interface display 240. This can illustratively be generated to allow the user 130 to define the new rule. In the embodiment shown in FIG. 2C, user interface 240 includes a rule name box 242 that allows the user to input the rule name. The user interface display 240 also illustratively includes a condition actuator 244, an action actuator 246, and a description actuator 248. The user can actuate the condition actuator 244 to set conditions upon which the new business logic rule is to fire. The user can actuate the action actuator 246 to specify an action that is to be taken when the conditions are met, and the user can actuate description actuator 248 to enter a textual description of the rule.

FIG. 2D shows another embodiment of user interface display 240 after the user has entered the rule name in box 242. It can be seen that the rule name is generally shown at 250. The user has chosen “Account Shipping Charge Adjustment” as the rule name.

FIG. 2E shows user interface display 240 where the user has actuated the condition actuator 244. Editor component 142 generates condition display 252 that has a plurality of controls 254, 256, 258 and 260 that allow user 130 to specify conditions upon which the present business logic rule is to fire. Specifically, display 252 includes field control 254, operator control 256, type control 258 and value control 260.

FIG. 2F shows that the user has actuated the field control 254 (which is displayed as a drop down menu, although any other types of controls can be used). This displays drop down menu 262 which includes a set of fields that can be specified by user 130.

FIG. 2G shows that the user has selected the “ship to state” field using control 254 and has now actuated the operator control 256. This causes editor component 142 to display drop down menu 264 which displays a set of operators that can be selected by the user.

FIG. 2H shows that the user has selected the “equals” operator from menu 264, and has gone on to actuate the value control 260, to have drop down menu 266 displayed. Drop down menu 266 displays a set of check boxes that apply to the “ship to state”. Of course, the values identified in drop down menu 266 will vary based upon the particular field selected by the user with field control 254. That is, because the user has chosen the “ship to state” field, the check boxes in menu 266 correspond to states. If the user had chosen another field, menu 266 would have different values in it. It can be seen in FIG. 2H that the user has selected the state of Oregon and the state of Washington in drop down menu 266.

FIG. 21 shows that the user has now fully specified the conditions under which the present business logic is to fire. As shown generally at 268 in FIG. 21, the present business logic rule will fire if the ship to state equals Washington or Oregon.

FIG. 2J shows that the user has now actuated the action actuator 246. In response, editor component 142 uses user interface component 146 to generate action menu 270. Menu 270 includes a plurality of different selectable actions that can be selected by user 130. Once one of those actions is selected, editor component 142 illustratively generates additional user interface displays that allow the user to more fully define that action. In the present example, the user has selected the “set field” action from menu 270.

FIG. 2K shows that, in response, editor component 142 generates action display 272 with a field control 274, a type control 276, and value control 278. Controls 274-278 allow the user to further define the action to be taken when the present business logic rule fires. FIG. 2K shows that the user has selected the “shipping charges” field and has set the value to “0” using controls 274 and 278. Therefore, when the present business logic rule fires (when it meets the conditions specified at 268) the action to be taken is to set the “shipping charges” to “0”.

FIG. 2L shows that the user has fully defined this action. FIG. 2L confirms, as shown generally at 280, that the action to be taken when this business logic rule fires is to set the shipping charge to 0.

FIG. 2M shows that the user wishes to set another action when this business logic rule fires. Recall that the user wishes to set the read/write status of the shipping charges field to read only status, when this business logic rule is to be applied. Therefore, the user again actuates action actuator 246 to generate the display of menu 270. The user then selects the “set read/write” action from menu 270.

FIG. 2N shows that, in response, editor component 142 generates action display 282 that allows the user to further specify the selected action. Display 282 includes field control 284 and status control 286. It can be seen that, using the field control 284, the user has selected the “shipping charges” field. Using the status control 286, the user has indicated that the read/write status of the “shipping charges” field is to be set to read only. Therefore, FIG. 20 shows that the user has now fully specified the conditions upon which the business logic rule is to fire, as well as the actions to be taken. That is, when this business logic rule fires, the shipping charge is to be set to 0 and the read/write status of the shipping charge field is to be set to read only (as shown generally at 280 and 288 in FIG. 20).

FIGS. 2P and 2Q illustrate that the user can edit the business logic rule, even while it is being created. For instance, assume that user 130 now wishes to delete the action of setting of the read/write status of the “shipping charge” field to read only. In that case, the user simply selects that action as shown generally at 290 in FIG. 2P. When the user selects an action, editor component 142 illustratively displays a set of controls that allow a user to modify that action. As seen in FIG. 2P, the up and down arrows 292 are displayed. When the user actuates these arrows, the user can move the selected action upward or downward in the order of actions taken when the rule applies. That is, the user can re-order the actions to be taken by using arrows 292. When the user actuates delete control 294, the user can delete the action.

In one embodiment, when the user deletes an action, editor component 142 illustratively generates a message to confirm that the user wishes to delete the action. In one example, FIG. 2Q shows that message 296 is generated to verify that the user wishes to delete the action. Once the user has deleted the action, editor component 142 illustratively generates a display (such as that shown in FIG. 2L above) indicating that the only action to be taken when this rule fires is to set the shipping charge to 0.

Once the user has fully defined the business logic rule, the user illustratively actuates activate button 241 to activate the rule within business system 102. FIG. 2R shows one embodiment of the user interface display 240 that indicates this. It can be seen that the active/inactive status indicator shown generally at 300 is now set to active. Also, a deactivate button 302 is set so that the user can illustratively deactivate this rule if he or she wishes. Receiving the user input activating the rule is indicated by block 301 in the flow diagram of FIG. 2.

Having fully defined the rule, editor component 142 illustratively generates code that is understandable by all of the selected contexts. This is indicated by block 302 in FIG. 2. For instance, in one embodiment, editor component 142 generates intermediate code 160. Intermediate code 160 is illustratively in a form that can be easily understood by all or most of the contexts, or that can be converted into a language that is easily understood by those contexts. In one embodiment, intermediate code 160 is XML or a variant form of XML, although other codes could be used as well. Conversion component 144 then illustratively converts the intermediate code 160, where necessary, into code or languages used in the various contexts. For instance, one or more conversion components 144 illustratively converts the code into client code for the various clients 110, 112 and 114. This is indicated by 303 in FIG. 2. A different (or the same) conversion component 144 then illustratively converts the code, as needed, to the server context as indicated by block 304 in FIG. 2.

Of course, other conversion components 144 can convert the code into other contexts as well. By way of example, assume that a new user context is to access business system 102 using a watch. In that case, an additional conversion component 144 is added to perform the desired conversions. Converting the code into other contexts is indicated by block 306 in FIG. 2.

Business system 102 then illustratively makes the code available for use in the various contexts as indicated by block 308. In one embodiment, the business logic rule is stored in data store 140, in the various languages that are understandable by the various contexts. Of course, it can also be stored in the intermediate code or in a universal code that is understandable by all contexts as well.

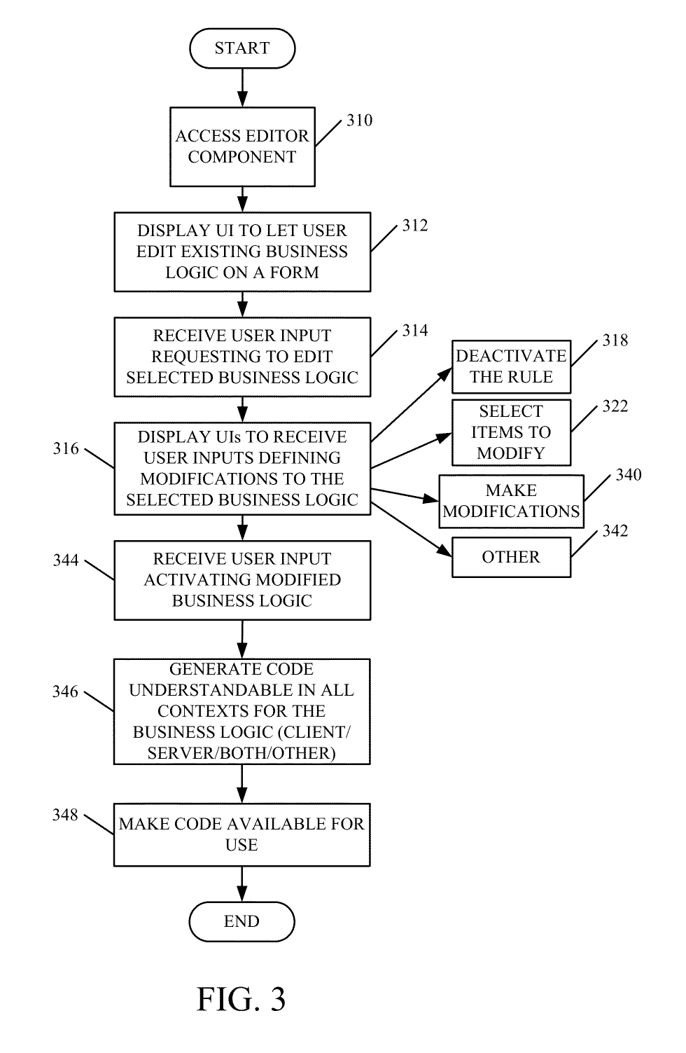

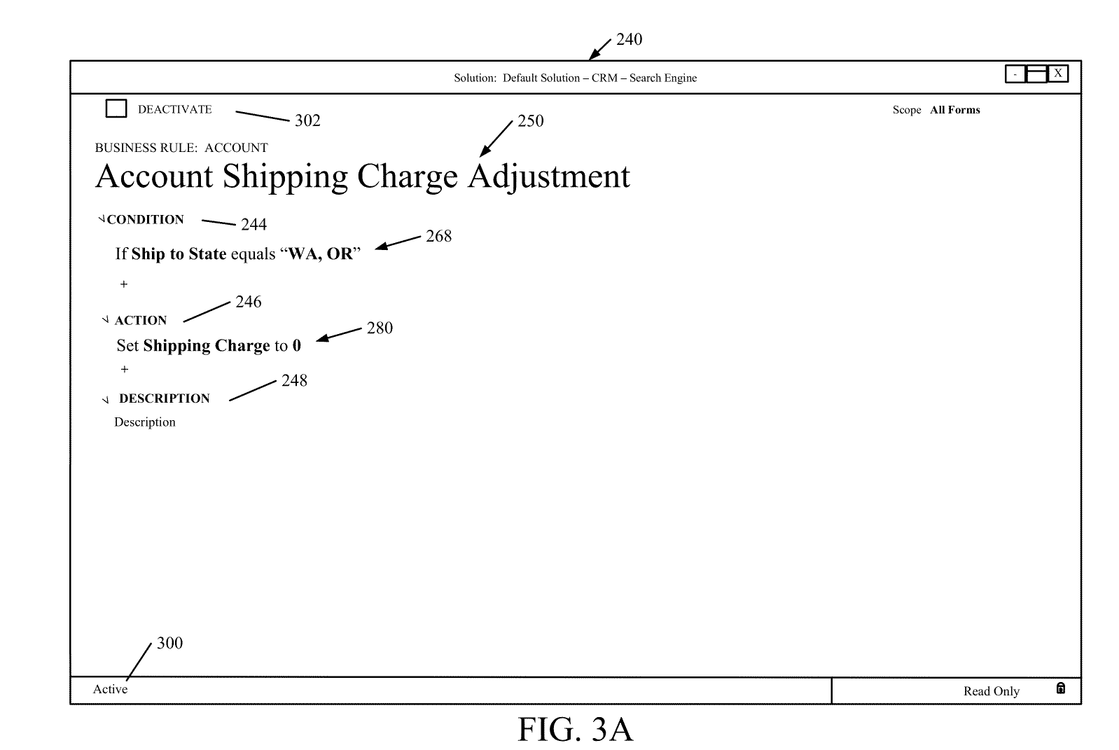

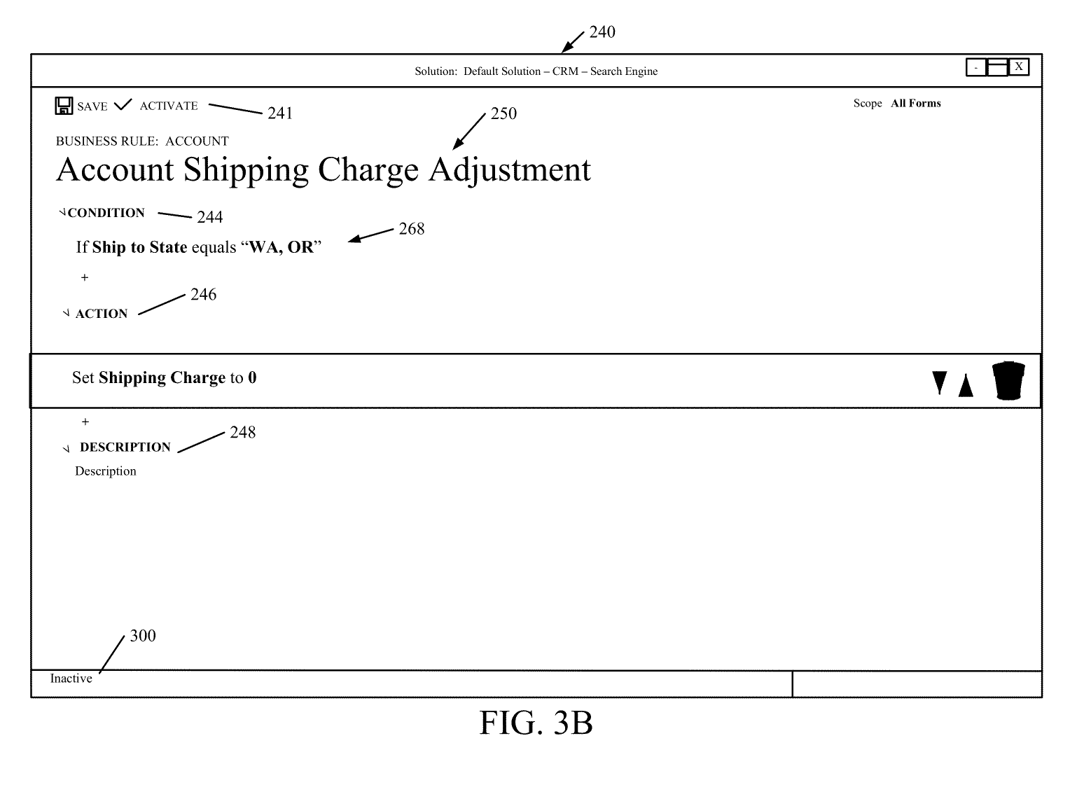

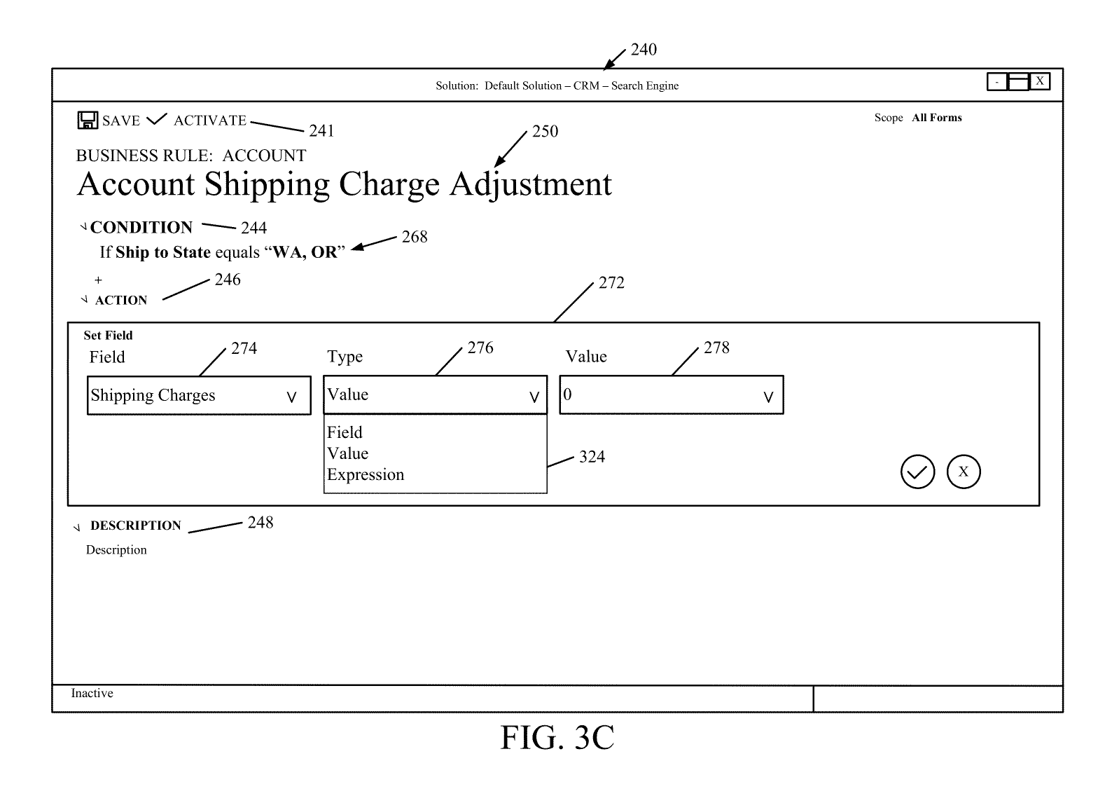

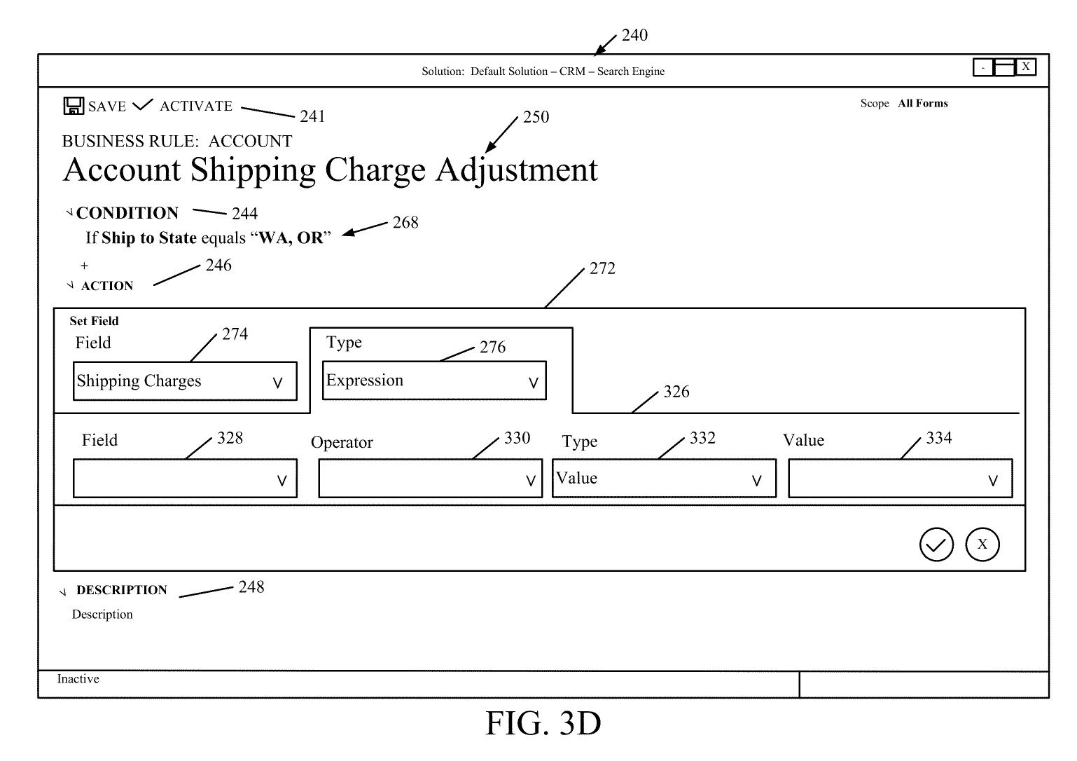

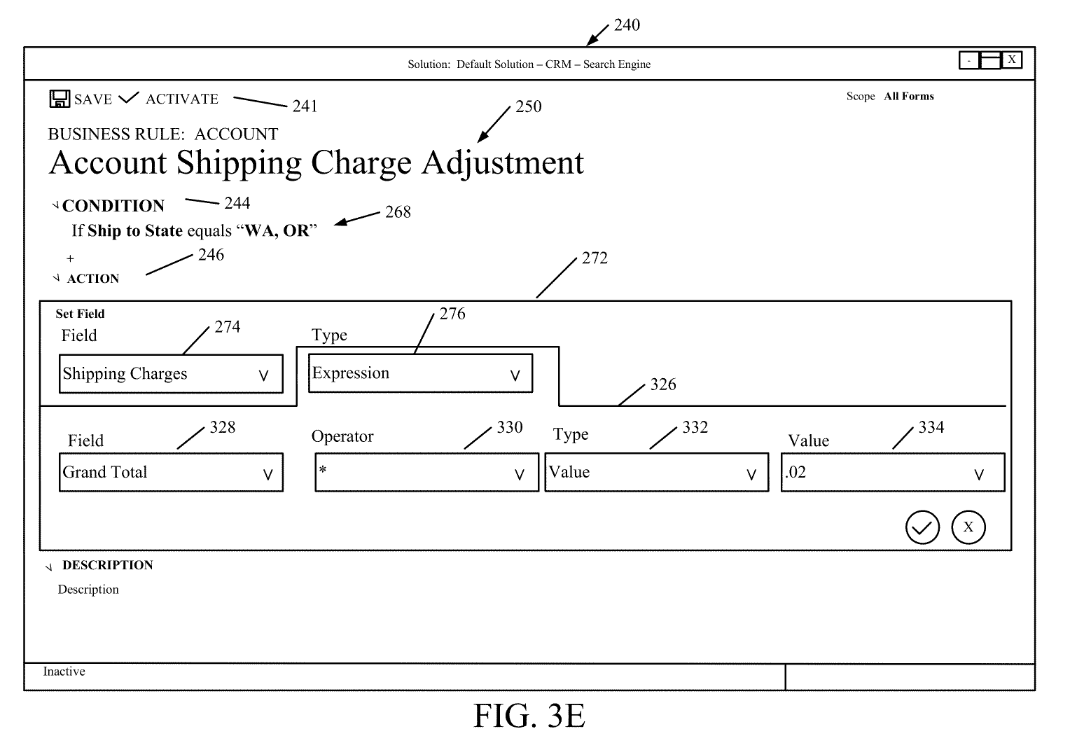

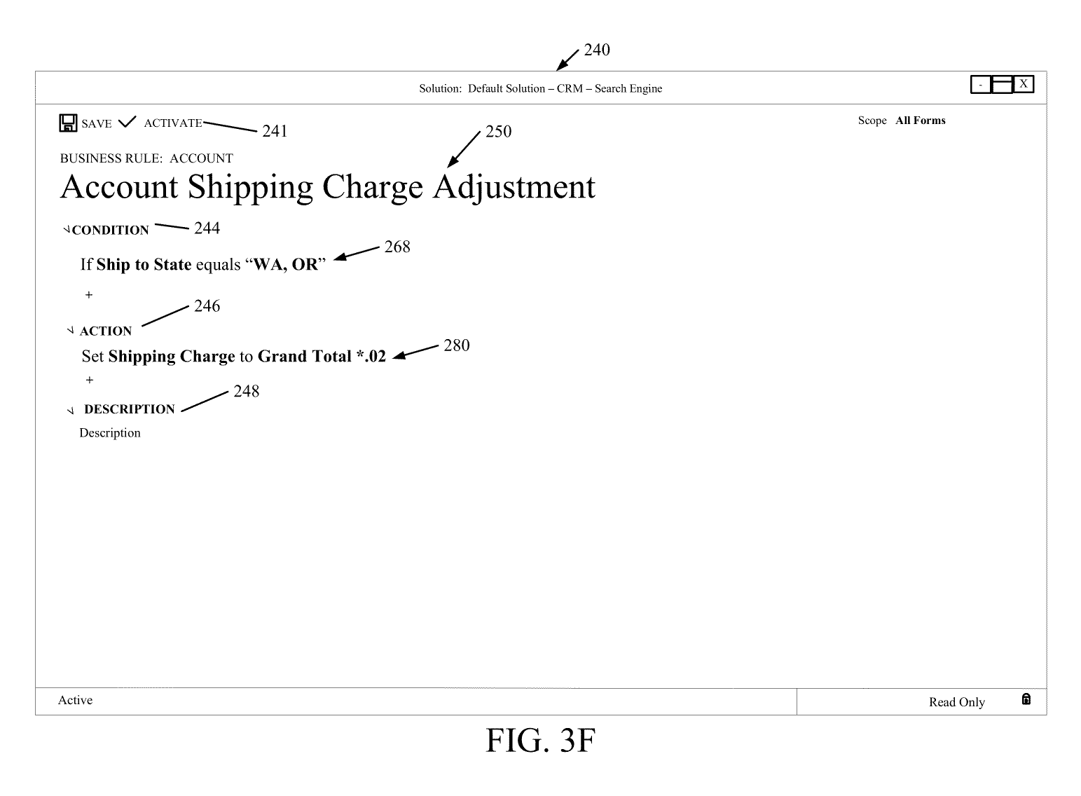

FIG. 3 is a flow diagram illustrating one embodiment of the operation of architecture 100 in allowing user 130 to edit an already-existing business logic rule. As with creating a new rule, user 130 first accesses business system 102 and specifically accesses the editor component 142 shown in FIG. 1. This is indicated by block 310.

Editor component 142 then illustratively generates a user interface display to allow user 130 to indicate that he or she wishes to edit an existing item of business logic on a form. This is indicated by block 312 in FIG. 3. By way of example, editor component 142 can illustratively generate the user interface display shown in FIG. 2B. In order to edit an already-existing rule, user 130 illustratively selects one of the rules from pane 232 and actuates the edit button 222. Receiving a user input requesting to edit a selected business logic rule is indicated by block 314 in FIG. 3.

Editor component 142 then illustratively generates user interface displays that allow the user to provide inputs defining modifications to the selected business logic rules. This is indicated by block 316. This can take a wide variety of forms. FIGS. 3A-3F are illustrative user interface displays that show this.

FIG. 3A is similar to the display shown in FIG. 2R, and similar items are similarly numbered. That is, the user has selected the “Account Shipping Charge Adjustment” rule for modification. In one embodiment, the user first actuates deactivate actuator 302 to deactivate the rule. This is indicated by block 318 in FIG. 2.

When the user does this, a display, such as the display shown in FIG. 3B, is displayed. It is similar to that shown in FIG. 3A, except that active/inactive status indicator 300 shows that the rule is now inactive, and activate button 241 is again displayed at the top of the screen.

The user then illustratively selects an item of the business logic rule to modify. For the present example, assume that the user wishes to now change the shipping charge value applied to all orders. Instead of being 0, it is now to be 2%. Thus, as shown in FIG. 3B, the user has selected the “set shipping charge to 0” action as indicated by 320 in FIG. 3B. If the user actuates this item (such as by double clicking it or otherwise), this selects the action and places it in edit mode so that its content can be edited. Selecting the item for modification is indicated by block 322 in the flow diagram of FIG. 3. In response, editor component 142 illustratively again generates the action display 324 that allows the user to modify the various parts of the action, using field control 274, type control 276, and value control 278.

FIG. 3C shows that the user has actuated the type control 276 to generate drop down menu 324. Drop down menu 324 allows the user to select a type for the action.

FIG. 3D shows that the user has selected the “expression” type from menu 324. This causes an additional display 326 to be displayed that allows the user to further define the expression. Display 326 includes a field control 328, an operator control 330, a type control 332, and a value control 334.

FIG. 3E shows that the user has used those controls to set the shipping charge field to have a value that is determined by multiplying the grand total field (using the multiplication operator) by 0.2. Thus, FIG. 3F shows that the business logic rule has been modified at 280 to show that the shipping charges are set to taking the grand total field and multiplying it by 0.2 (that is, 2%). Making these modifications or other modifications are indicated by block 340 and 342 in the flow diagram of FIG. 3. The user then illustratively activates the modified rule by actuating the activate button 241. Receiving the user input activating the modified business logic rule is indicated by block 344 in FIG. 3.

Again, editor component 142 illustratively generates code that is understandable in all of the selected contexts for this business rule, to correctly reflect the modification. This is indicated by block 346 in FIG. 3. Business system 102 then again makes the code available for use in the various contexts. This is indicated by block 248.

It can thus be seen that even the user who does not understand how to code in the various contexts can create and modify business logic rules using natural language inputs and selections through a graphical user interface. The editor component automatically generates code that is understandable (or is automatically convertible into a form that is understandable) in all of the various contexts. The system is extensible in that different conversion components can be added to convert intermediate code into various different formats or languages understandable in different contexts.

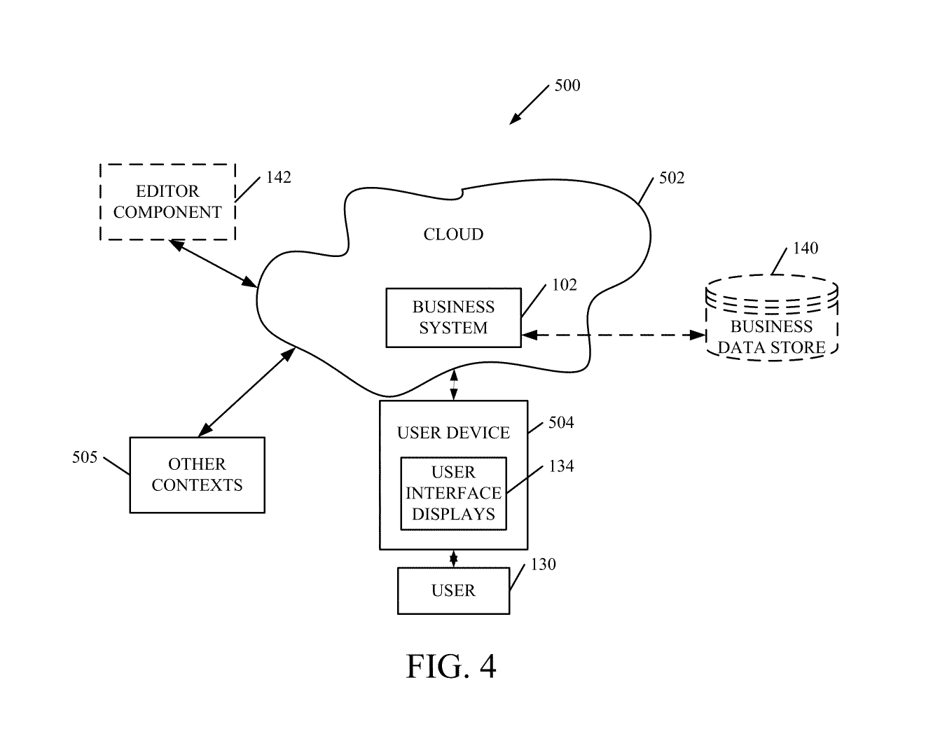

FIG. 4 is a block diagram of architecture 100, shown in FIG. 1, except that it's elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that business system 102 is located in cloud 502 (which can be public, private, or a combination where portions are public while others are private). Therefore, user 130 uses a user device 504 includes tenant 104 to access those systems through cloud 502. FIG. 4 shows other contexts 505 (such as the clients and server environments in FIG. 1) accessing business system 102 in cloud 502.

FIG. 4 also depicts another embodiment of a cloud architecture. FIG. 4 shows that it is also contemplated that some elements of business system 102 are disposed in cloud 502 while others are not. By way of example, data store 140 can be disposed outside of cloud 502, and accessed through cloud 502. In another embodiment, editor component 142 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

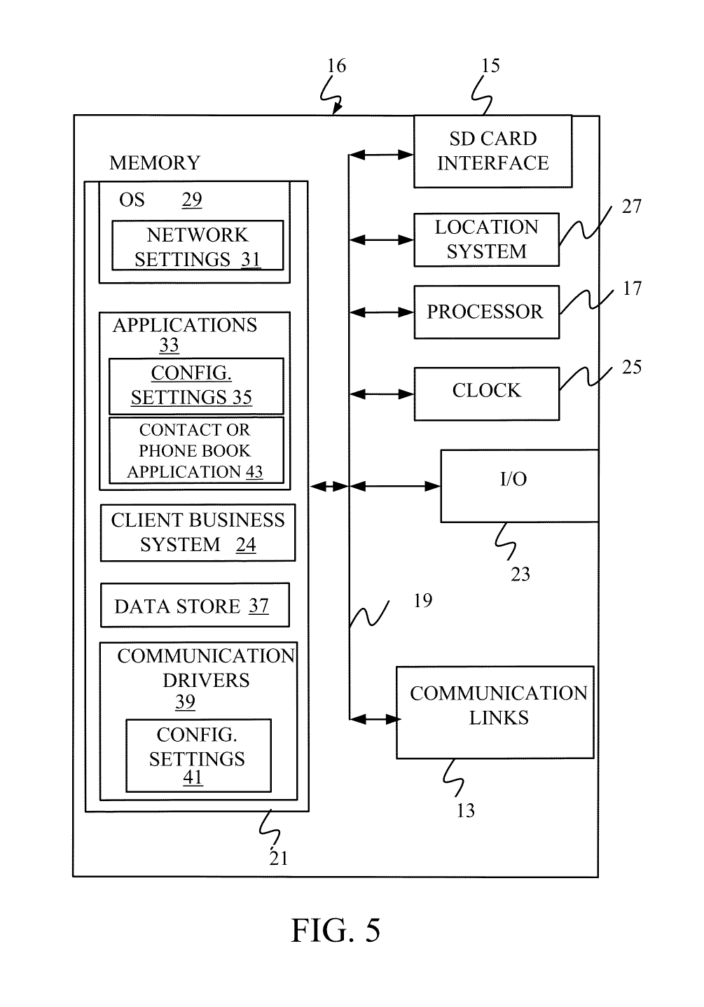

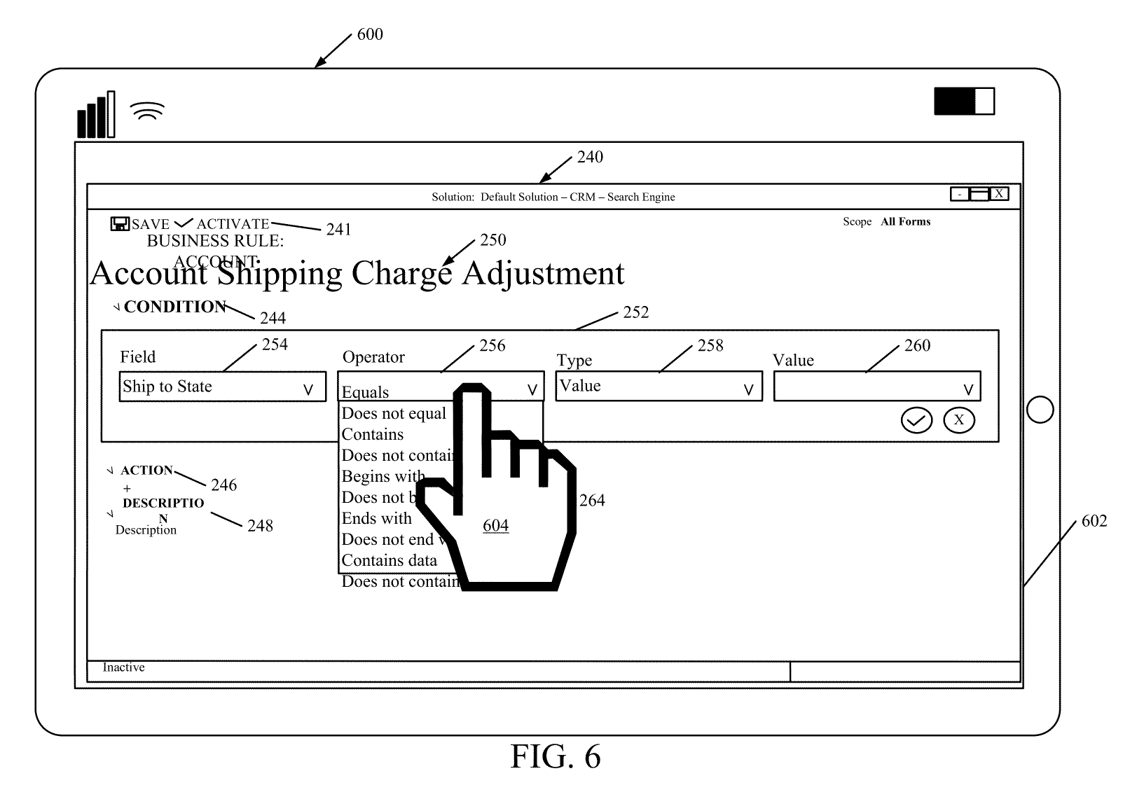

FIG. 5 is a simplified block diagram of one illustrative embodiment of a handheld or mobile computing device that can be used as a user's or client's hand held device 16, in which the present system (or parts of it) can be deployed. FIGS. 6-10 are examples of handheld or mobile devices.

FIG. 5 provides a general block diagram of the components of a client device 16 that can run components of business system 102 or the other contexts that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 138 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display 240 (From FIG. 2G) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

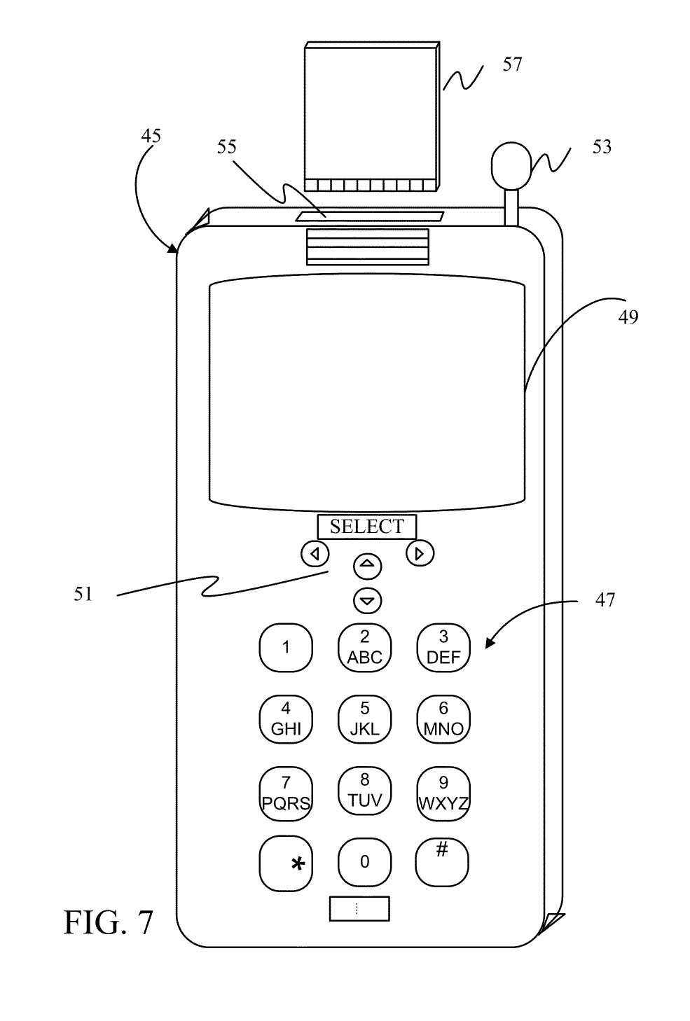

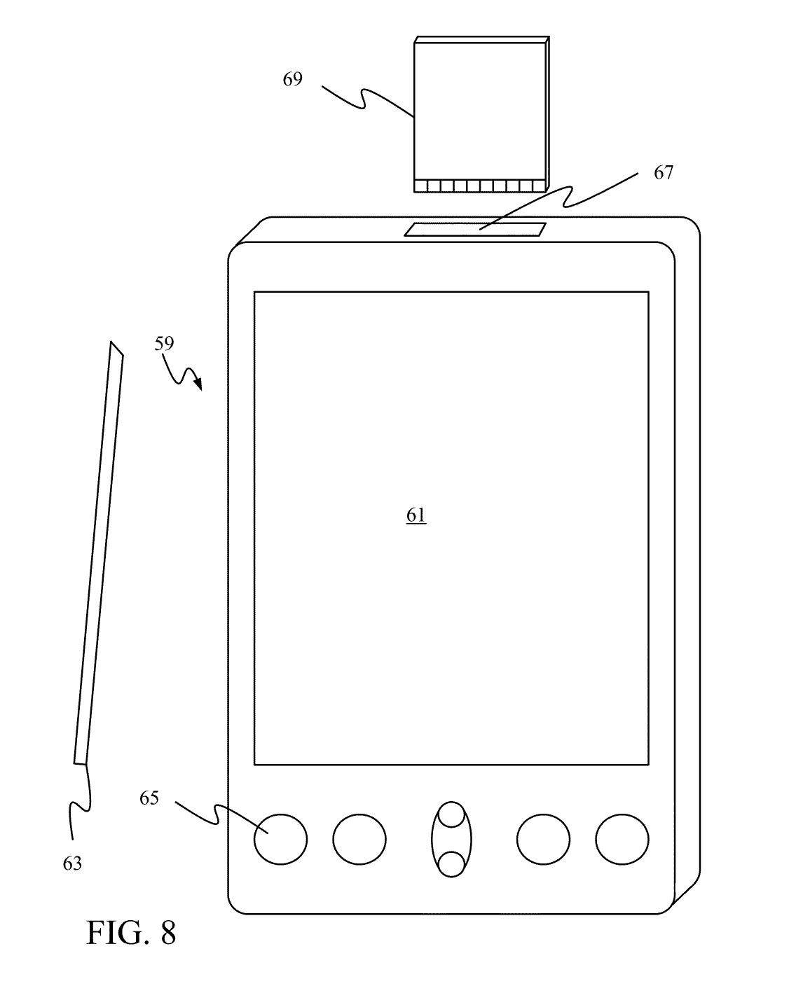

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

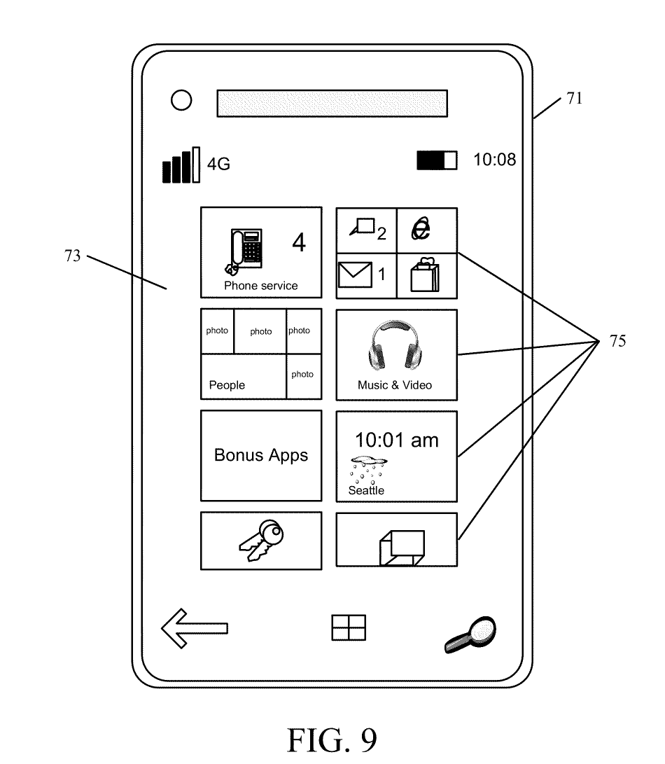

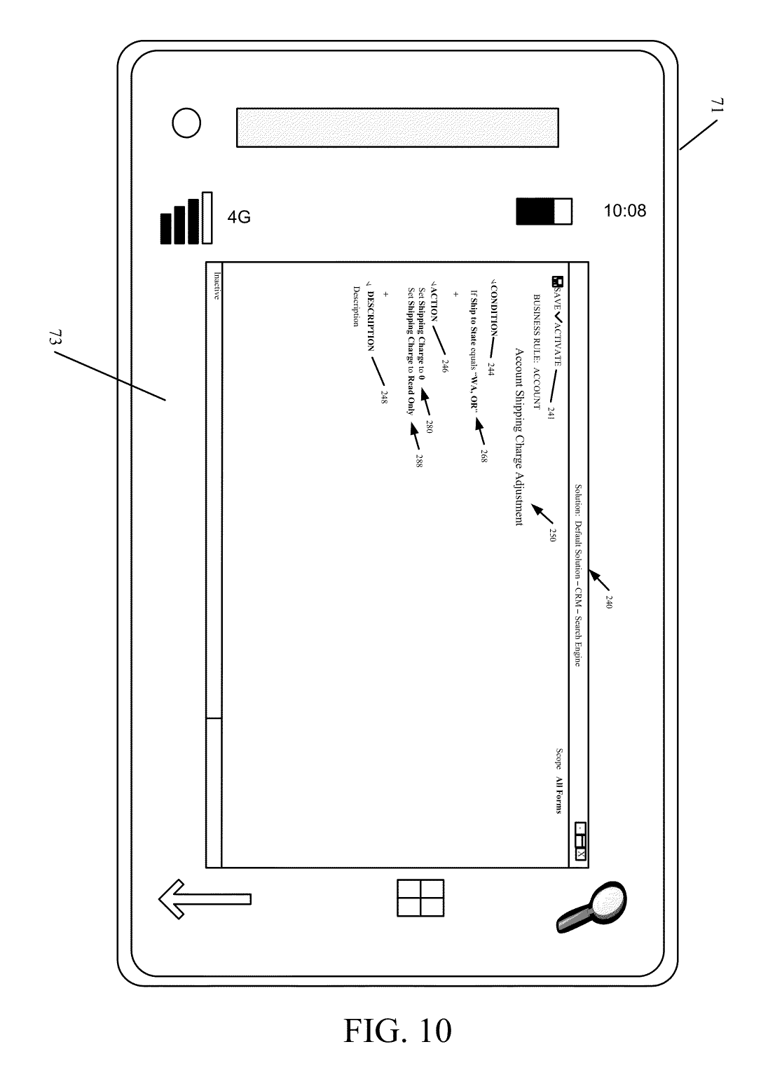

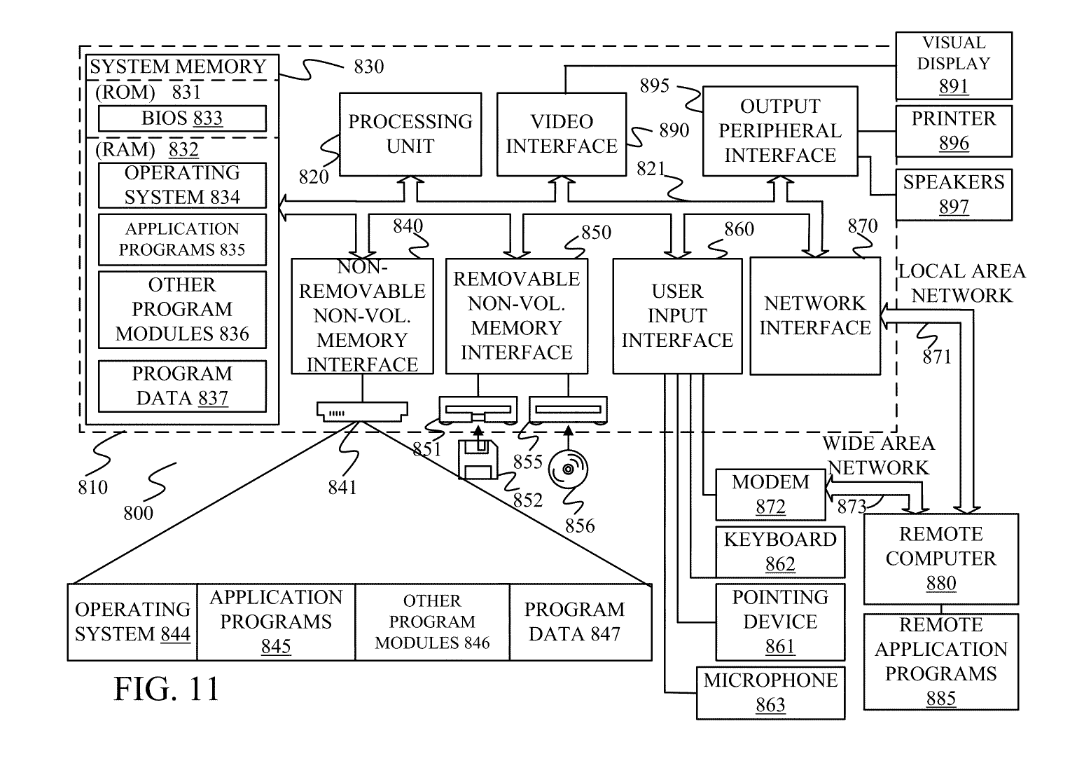

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows smart phone 71 with the display from FIG. 20 displayed on it.

Note that other forms of the devices 16 are possible.

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 138), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of generating logic for a form, comprising:
displaying a rule definition user interface display with first user input mechanisms that receive rule definition user inputs defining a logic rule that is applied to a given form in a computer system;
automatically generating code representing the logic rule defined by the user definition user inputs, executable in a plurality of different contexts, to implement the logic rule on the given form.

2. The computer-implemented method of claim 1 wherein the computer system comprises a business system and the form comprises a business form in the business system, and wherein receiving the rule definition user inputs comprises:
receiving business logic rule definition inputs defining a business logic rule applied to the business form in the business system.

3. The computer-implemented method of claim 2 wherein automatically generating code comprises:
automatically generating different code with a different conversion component for each different context to implement the business logic rule on the business form in each of the different contexts.

4. The computer-implemented method of claim 3 wherein automatically generating different code for each different context comprises:
automatically generating code for a client context comprising a mobile companion application that is a companion to the business system and run on a mobile device.

5. The computer-implemented method of claim 3 wherein automatically generating different code for each different context comprises:
automatically generating code for a client context comprising a web browser application run on a client device.

6. The computer-implemented method of claim 3 wherein automatically generating different code for each different context comprises:
automatically generating code for a client context comprising a personal information manager application run on a client device.

7. The computer-implemented method of claim 3 wherein automatically generating different code for each different context comprises:
automatically generating code for a client context comprising a server application that is run in a developer environment on a client device.

8. The computer-implemented method of claim 3 wherein automatically generating code comprises:
generating intermediate code; and
converting the intermediate code into code understandable by a device with an application in each of the different contexts.

9. The computer-implemented method of claim 8 wherein generating the intermediate code comprises:
generating the intermediate code as XML code or a variant of XML code.

10. The computer-implemented method of claim 2 wherein receiving business logic rule definition inputs defining a business logic rule applied to the business form in the business system comprises:
displaying a criteria user interface display; and
receiving criteria user inputs through the criteria user interface display defining criteria for firing the business logic rule on the business form.

11. The computer-implemented method of claim 10 wherein receiving business logic rule definition inputs defining a business logic rule applied to the business form in the business system comprises:
displaying an action user interface display; and
receiving action user inputs through the action user interface display defining an action taken when the business logic rule fires on the business form.

12. The computer-implemented method of claim 2 wherein receiving business logic rule definition inputs defining a business logic rule applied to the business form in the business system comprises:
displaying a context control that receives context user inputs indicative of selected contexts in which the business logic rule applies.

13. The computer-implemented method of claim 2 wherein receiving business logic rule definition inputs defining a business logic rule applied to the business form in the business system comprises:
displaying a rule control that receives a user request input indicative of a user request to create a new business logic rule or to modify an existing business logic rule.

14. A computer system, comprising:
an application that displays forms for performance of tasks;
an editor component that displays a rule definition user interface display with first user input mechanisms that receive rule definition user inputs defining a logic rule that is applied to a given form in the application, the editor component;
automatically generating code representing the logic rule defined by the definition user inputs, the code being executable in a plurality of different contexts, to implement the logic rule on the given form; and
a computer processor that is a functional part of the computer system and activated by the application and the editor component to facilitate displaying the rule definition user interface display, defining the logic rule, and automatically generating the code.

15. The computer system of claim 14 wherein the computer system comprises a business system and the form comprises a business form in the business system, and wherein the editor component receives business logic rule definition inputs defining a business logic rule applied to the business form in the business system.

16. The computer system of claim 15 wherein the editor component generates a intermediate code indicative of the business logic rule, and further comprising:
a conversion component that converts the intermediate code into code that is executable in at least one of the plurality of different contexts.

17. The computer system of claim 15 wherein the editor component displays a criteria user interface display and receives criteria user inputs through the criteria user interface display defining criteria for firing the business logic rule on the business form.

18. The computer system of claim 17 wherein the editor component displays an action user interface display and receives action user inputs through the action user interface display defining an action taken when the business logic rule fires on the business form.

19. A computer readable storage medium that stores computer executable instructions which, when executed by a computer, cause the computer to perform a method, comprising:
displaying a rule definition user interface display with first user input mechanisms that receive rule definition user inputs defining a logic rule that is applied to a given form in a computer system; and
automatically generating code representing the logic rule defined by the user definition user inputs, executable in a plurality of different client contexts, to implement the logic rule on the given form., the client contexts including a mobile client context and a server client context.

20. The computer readable storage medium of claim 19 wherein the computer system comprises a business system and the form comprises a business form in the business system, and wherein receiving the rule definition user inputs comprises:
receiving business logic rule definition inputs defining a business logic rule applied to the business form in the business system.
